(19) United States
(12) Patent Application Publication
(10) Pub. No.: US 2010/0193358 A1
(43) Pub. Date: Aug. 5, 2010

(54) MICROPARTICLE MEASURING APPARATUS AND MICROPARTICLE MEASURING METHOD

(75) Inventor: Ryou Hamada, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/678,371

(22) PCT Filed: Aug. 7, 2008
(86) PCT No.: PCT/JP2008/002164

§ 371 Date: Mar. 16, 2010

(30) Foreign Application Priority Data
Sep. 18, 2007 (JP) P2007-241345

(51) Int. Cl. G01N 27/447

(52) U.S. Cl. 204/547; 204/643

(57) ABSTRACT

A microparticle measuring apparatus and microparticle measuring method which, in sample liquids having different electric conductivities, have a sensitivity and accuracy which are necessary and sufficient, without performing pretreatment of reducing the electric conductivity are provided. The microparticle measuring apparatus includes: a cell 1 into which a liquid containing microparticles is to be introduced; at least one pair of electrodes which are immersed in the cell 1; a migration power supply unit 4 which applies an AC voltage of a frequency at which a dielectrophoretic force on the microparticles is equal to or larger than a predetermined value, between the pair of electrodes; a measurement unit 5 which measures the microparticles in the cell; and a control calculation unit 6 which calculates a result of the measurement performed by the measurement unit, and which calculates the concentration of the microparticles in the liquid.

### TECHNICAL FIELD

The present invention relates to a microparticle measuring apparatus and microparticle measuring method for measuring the number of microparticles in a sample liquid by using dielectrophoresis, and more particularly to a microparticle measuring apparatus and microparticle measuring method in which an influence of the electric conductivity of a solution is avoided without performing pretreatment, and which performs measurement highly sensitively and highly accurately.

### BACKGROUND ART

Recently, it is particularly highly needed to rapidly, simply, and highly sensitively perform a quantitative measurement on microorganisms which may cause food poisoning or an infectious disease to do any harm to the human body, because, in a step of producing food, a clinic unequipped with a microorganisms test facility, or the like, when a microorganisms test is performed on the spot, it is possible to prevent food poisoning or an infectious disease from occurring.

In a so-called bio-sensor, when a biochemical substance in a sample is to be quantitatively measured by using artificial microparticles such as polystyrene labeled with a substance which is to be uniquely bonded to the measuring object, such as an antibody, it is necessary to quantitatively measure the number of microparticles in the sample or their bonding state. As described above, today, it is highly requested to rapidly, simply, and highly sensitively perform a quantitative measurement on microparticles contained in a liquid.

Here, the definition of the microparticles in the application will be described. The microparticles in the application are such as: polystyrene and the like substances, and particles in which any coating is applied to the substance; carbon nanotubes; metal particles such as gold colloids; and a living body or microparticles derived from a living body in a broad sense including small ones of so-called microorganisms, protozoans, and protozoas classified as a bacterium, a fungus, an actinomycete, a rickettsia, mycoplasma, or virus, larvae of organisms, cells of animals and plants, sperms, blood cells, nuclei acid, proteins, and the like. In addition, the microparticles in the application mean all particles which can be subjected to dielectrophoresis. In the application, particularly, measurement on microorganisms is assumed.

Conventionally, the most widely used method of testing microorganisms is the culture method. In the culture method, a sample of microorganisms is smeared on a culture medium, the cultivation is performed under growth conditions for the microorganisms, and the number of colonies formed on the culture medium is counted, thereby quantitating the number of the microorganisms.

However, the colonization requires usually one to two days, or several weeks depending on the kind of microorganisms, and hence there is a problem in that the test cannot be rapidly performed. Furthermore, operations such as concentration, dilution, and smearing on the culture medium are necessary. Such operations must be performed by an expert. Consequently, there are problems in that the test cannot be simply performed, and that the accuracy is lowered by operational variations.

In order to solve the conventional problems, the inventor and other inventors have proposed a DEPIM (Dielectrophoretic Impedance Measurement Method) method in which dielectrophoresis and a impedance measurement are combined with each other, as a rapid, simple, and highly sensitive method of counting the number of microorganisms (for example, see Patent Reference 1).

In the DEPIM method, microorganisms are collected on microelectrodes by a dielectrophoretic force, and at the same time an impedance change of the microelectrodes is measured, thereby quantitatively measuring the number of microorganisms in a sample liquid. Hereinafter, the measurement principle will be briefly described.

Usually, microorganisms have a structure where a cytoplasm and cell wall which are ion-rich and high in dielectric constant and electric conductivity are surrounded by a cell membrane which is relatively low in dielectric constant and electric conductivity, and can be deemed as dielectric particles. In the DEPIM method, a dielectrophoretic force which is a force acting, in a constant direction, on dielectric particles that are polarized in an electric field is used, and microorganisms which are dielectric particles are collected in the gap between the microelectrodes.

It is known that a dielectrophoretic force F_{DEP} which acts on dielectric particles is given by following (Exp. 1) (for example, see Non-patent Reference 1). Hereinafter, description will be made while taking the case where dielectric particles are microorganisms, as an example.

F_{DEP}=2πa³ε₀εₘRe[K]∇E² [Exp. 1]

where a: the radius of a microorganism in case of sphere approximation, ε₀: dielectric constant in vacuum, εₘ: relative dielectric constant of a sample liquid, and E: electric field intensity, and ∇ is an operator indicating the gradient. In this case, ∇E² shows the gradient of the electric field E², and means the degree of inclination of E² at the position, i.e., how steeply the electric field E spatially changes. Furthermore, K is called the Clausius-Mossotti factor, and indicated by (Exp. 2), and Re[K]>0 indicates positive dielectrophoresis in which the microorganisms are caused to migrate in the same direction as the electric field gradient, i.e., toward the electric field concentrated portion. Re[K]<0 indicates negative dielectrophoresis in which the microorganisms are caused to migrate in the direction separating from the electric field concentrated portion, i.e., toward a weak electric field portion.

$$K = \frac{{ɛ}_{b}^{*} - {ɛ}_{m}^{*}}{{ɛ}_{b}^{*} + 2 {ɛ}_{m}^{*}} \qquad [ Exp . 2 ]$$

where ε_{b}* and εₘ* indicate the complex dielectric constants of the microorganisms and a solution, respectively. Usually, a complex dielectric constant εᵣ* is indicated by (Exp. 3).

$${ɛ}_{r}^{*} = {ɛ}_{r} - j \frac{σ}{ω {ɛ}_{0}} \qquad [ Exp . 3 ]$$

where εᵣ: relative dielectric constant of the microorganisms or the sample liquid, σ: electric conductivity of the microorganisms or the sample liquid, and ω: angular frequency of the applied electric field.

From (Exp. 1), (Exp. 2), and (Exp. 3), it is seen that the dielectrophoretic force depends on the radius of a microorganism, the real part (hereinafter, indicated as Re[K]) of the Clausius-Mossotti factor, and the electric field intensity. Furthermore, it is seen that Re[K] is changed in dependence on the complex dielectric constants of the sample liquid and the microorganisms, and the frequency of the electric field.

In the DEPIM method, therefore, these parameters must be adequately selected, so that the dielectrophoretic force acting on the microorganisms is made sufficiently large and the microorganisms are surely collected in the electrode gap. The DEPIM method is characterized in that the electrical measurement is performed simultaneously with the microorganism collection to the electrodes by the dielectrophoresis, thereby quantitatively measuring the number of microorganisms in the sample liquid.

A microorganism has the above-described structure, and hence can be deemed as a microparticle which has electrically a specific impedance. When the number of microorganisms which are collected in the gap between the microelectrodes by dielectrophoresis is increased, therefore, the impedance between the electrodes is changed in accordance with the number of collected microorganisms.

Therefore, the inclination of a time change of the inter-electrode impedance has a value according to the number of microorganisms which are collected in the electrode gap per unit time, and the degree of the inclination corresponds to the concentration of the microorganisms in the sample liquid. When the inclination of a time change of the inter-electrode impedance is measured, consequently, it is possible to measure the concentration of the microorganisms in the sample liquid, or in other words the number of the microorganisms.

In the DEPIM method, furthermore, the number of the microorganisms is quantitated from the inclination of a time change of the impedance immediately after the start of dielectrophoresis, whereby the measurement of microorganisms is realized for short time period. In the above, the measurement principle of the DEPIM method has been briefly described. For details of the principle, please refer Non-patent Reference 2.

The sample liquid which is used in the measurement in the application is assumed to be a liquid in which microorganisms harvested by any method, such as blood or saliva is suspended in a liquid of a low electric conductivity and containing water as the principal constituent. It is seemed that, when microorganisms are harvested, not only microorganisms but also ions contained in the vicinity are simultaneously harvested. In this case, the dielectric constant of the sample liquid has a value which is substantially equal to that of water, with the result that the dielectrophoretic force acting on the microorganisms depends on the ion concentration of the sample liquid, or in other words the electric conductivity.

As the electric conductivity of a sample liquid is higher, usually, the dielectrophoretic force is smaller. In the case where it is assumed that a sample liquid such as described above is measured by the conventional DEPIM method, therefore, there is a problem in that, in a sample which has a high sample liquid electric conductivity, the dielectrophoretic force acting on microorganisms is reduced, and the number of microorganisms collected on microelectrodes is decreased, with the result that the measurement sensitivity is lowered. Moreover, the dielectrophoretic force acting on microorganisms is different depending on the sample liquid electric conductivity, and hence there is a problem in that, when sample liquids of different electric conductivities are measured, the dispersion of measurement results is large.

As means for solving the problems in measurement of microorganisms or the like using dielectrophoresis, a technique is known in which, before measurement, the sample liquid electric conductivity is reduced by ion exchange or the like. The technique is a method in which, before analysis, a sample liquid is treated in an ion-exchange column to reduce the sample electric conductivity, and thereafter microorganisms in the sample liquid are analyzed by dielectrophoresis (for example, see Patent Reference 2).

Also a method is known in which the existence of a biological specific reactive substance is detected or measured by the biological specific agglutination reaction on carrier particles. In the method, an AC voltage is applied to the reaction system under coexistence of a salt, whereby the existence of a biological specific reactive substance is detected or measured more rapidly, more simply, and more highly sensitively than a conventional method (for example, see Patent Reference 3).

Also a microorganism activity measuring apparatus which, when the activity of microorganisms is to be measured, performs rapid measurement in substantially real time to detect quantitatively and simply the activity of the microorganisms, and a microorganism activity measuring method which is used in the measurement are known. In the method, the kind of the microorganisms and the electric conductivity of a sample liquid are input, and a voltage (the amplitude and the frequency) which is optimum for measuring the activity is selected from Table 1 (for example, see Patent Reference 4).

TABLE 1

| | | | Optimum frequency for |
|---|---|---|---|
| Name of | Conductivity of | | measuring degree of |
| microorganism | suspension | Voltage | activity |
| Escherichia coil | 0.1 mS/n | 3 Vpp | 1 MHz |
| Pseudomonas | 0.1 mS/n | 3 Vpp | 5 MHz |
| aeruginosa | | | |
| Klebsiella | 0.1 mS/n | 3 Vpp | 10 MHz |
| pneumoniae | | | |

Patent Reference 1: JP-A-2000-125846

Patent Reference 2: JP-T-11-501210

Patent Reference 3: JP-A-7-083928

Patent Reference 4: JP-A-2003-000224

Non-patent Reference 1: Hywel Morgan et al.: “AC Electrokinetics: colloids and nanoparticles”, RESERCH STUDIES PRESS LTD., published in 2003, pp. 15-63

Non-patent Reference 2: J. Suchiro, R. Yatsunami, R. Hamada, M. Hara, and J. Phys. D: Appl. Phys. 32(1999)2814-2820

### DISCLOSURE OF THE INVENTION

### Problems to be Solved by the Invention

In Patent Reference 1, an example in which a sinusoidal AC voltage with a peak to peak voltage of 100 V at a frequency of 1 MHz is applied between flat plate electrodes is shown, and it is described that the frequency of the AC to be applied at this time can be arbitrarily selected from a frequency range where dielectrophoresis occurs. However, there is no suggestion about avoiding the influence of the solution electric conductivity by selecting the frequency.

In the technique disclosed in Patent Reference 2, pretreatment of ion exchange is necessary before the analysis by dielectrophoresis, and hence there are problems in that the simplicity of microorganism measurement is impaired, and that the whole measurement requires a prolonged period of time. Moreover, the electric conductivity of the sample liquid after the ion exchange treatment depends on that before the ion exchange treatment. Therefore, it is impossible to solve the problem in that dispersion of the electric conductivity among samples causes dispersion in results of microorganism measurement by using dielectrophoresis such as the DEPIM method.

In Patent Reference 3, the frequency range of the AC voltage is disclosed. However, pearl chain formation and dielectrophoresis are different phenomena, and, at a salt concentration of 10 mM (about 1,000 μS/cm), dielectrophoresis does not occur. Namely, the electric conductivity of an NaCl solution of 10 mM is about 1,000 μS/cm. Under such high solution conductivity conditions, it is difficult to trap microorganisms to the electrodes by “positive dielectrophoresis”.

In the microorganism activity measuring apparatus of Patent Reference 4, the kind of the microorganisms and the electric conductivity of a sample liquid are input, and a voltage (the amplitude and the frequency) which is optimum for measuring the activity is selected from the table. A frequency at which a difference is formed in the dielectrophoretic force depending on the activity state is selected.

The invention has been made in view of the above-discussed circumstances, and an object thereof is to provide a microparticle measuring apparatus and microparticle measuring method which, also in the case of a sample liquid having a high solution electric conductivity, can perform measurement simply and at a sensitivity and accuracy which are necessary and sufficient, without performing pretreatment of reducing the electric conductivity.

### Means for Solving the Problems

The inventors have found that, when microparticles, particularly bacteria are to be subjected to dielectrophoresis, there is a frequency region where the influence of the solution conductivity can be avoided. The invention has been accomplished on the basis of this finding.

The microparticle measuring apparatus of the invention includes: a cell into which a liquid containing microparticles is to be introduced; at least one pair of electrodes which are immersed in the cell; a migration power supply unit which applies an AC voltage of a frequency at which a dielectrophoretic force exerted on the microparticles is equal to or larger than a predetermined value, between the pair of electrodes; a measurement unit which measures the microparticles in the cell; and a control calculation unit which calculates a result of the measurement performed by the measurement unit, and which calculates a concentration of the microparticles in the liquid.

According to the configuration, the AC voltage of a frequency at which a dielectrophoretic force exerted on the microparticles is equal to or larger than the predetermined value is applied between the pair of electrodes, whereby a sufficient dielectrophoretic force is caused to act irrespective of variation of the solution electric conductivity. Also in the case of a sample liquid having a high solution electric conductivity, therefore, the number of the microparticles can be measured simply and at a sensitivity and accuracy which are necessary and sufficient, without performing pretreatment of reducing the solution electric conductivity.

In the microparticle measuring apparatus of the invention, furthermore, the control calculation unit has a frequency table which stores frequencies of the AC voltage at which the dielectrophoretic force exerted on the microparticles is equal to or larger than the predetermined value, in a case where the solution electric conductivity is set as a parameter.

According to the configuration, when the frequency table is referred, it is possible to rapidly select a frequency at which the microparticles are efficiently collected.

In the microparticle measuring apparatus of the invention, furthermore, the migration power supply unit applies an AC voltage of a frequency of 500 KHz to 3 MHz between the pair of electrodes.

According to the configuration, an AC voltage of a frequency of 500 KHz to 3 MHz is applied between the pair of electrodes. Therefore, the dielectrophoretic force on the microparticles is equal to or larger than the predetermined value, and hence the number of the microparticles can be measured simply and at a sensitivity and accuracy which are necessary and sufficient, without performing pretreatment of reducing the solution electric conductivity.

In the microparticle measuring apparatus of the invention, furthermore, the measurement unit measures an impedance between the pair of electrodes, and the control calculation unit calculates a time change of the impedance between the pair of electrodes to calculate a number of the microparticles in the cell.

According to the configuration, the number of the microparticles can be calculated from the time change of the impedance between the electrodes.

In the microparticle measuring apparatus of the invention, furthermore, the microparticles are collected between a gap of the pair of electrodes by the dielectrophoretic force in positive dielectrophoresis.

According to the configuration, the microparticles are collected between the gap of the pair of electrodes by the dielectrophoretic force, and hence the number of the microparticles can be measured rapidly, simply, and highly sensitively.

In the microparticle measuring apparatus of the invention, furthermore, the control calculation unit calculates a number of the microparticles in the sample liquid from a time change of a capacitance between the pair of electrodes.

According to the configuration, the number of the microparticles in the sample liquid is measured from the time change of the capacitance, and hence the number of the microparticles can be measured rapidly, simply, and highly sensitively.

In the microparticle measuring apparatus of the invention, furthermore, an electric conductivity of the sample liquid is in a range of 0 to 150 μS/cm.

According to the configuration, with respect to an oral sample which is most frequently measured, the number of the microparticles can be measured simply and at a sensitivity and accuracy which are necessary and sufficient.

In the microparticle measuring apparatus of the invention, furthermore, the migration power supply unit applies an AC voltage of a frequency at which a dielectrophoretic force is larger by about 50% or more than a maximum dielectrophoretic force in a case where the solution electric conductivity is lowest.

According to the configuration, it is possible to ensure a sensitivity and accuracy which are necessary and sufficient.

Moreover, the microparticle measuring apparatus of the invention further includes a solution electric conductivity measurement unit which measures the solution electric conductivity.

According to the configuration, it is possible to measure the concentration of the microparticles simply and at a sensitivity and accuracy which are necessary and sufficient, in accordance with the solution electric conductivity.

Moreover, the microparticle measuring apparatus of the invention further includes at least one pair of electrodes for measuring the solution electric conductivity, and measures an impedance between the electrodes for measuring the solution electric conductivity, thereby measuring the solution electric conductivity.

According to the configuration, it is possible to measure the concentration of the microparticles simply and at a sensitivity and accuracy which are necessary and sufficient, in accordance with the solution electric conductivity.

In the microparticle measuring apparatus of the invention, furthermore, the pair of electrodes are used for performing dielectrophoresis and measuring the solution electric conductivity.

According to the configuration, dielectrophoresis and the measurement of the solution electric conductivity are performed by the same electrodes, and hence the microparticle measuring apparatus can be simplified.

In the microparticle measuring apparatus of the invention, furthermore, a voltage for measuring the solution electric conductivity, and a voltage for dielectrophoresis are different from each other.

According to the configuration, the voltage for measuring the solution electric conductivity, and that for dielectrophoresis are different from each other, and hence the respective optimum voltages can be selected.

In the microparticle measuring apparatus of the invention, furthermore, the voltage for measuring the solution electric conductivity is lower than the voltage for dielectrophoresis.

According to the configuration, the voltage for measuring the solution electric conductivity is lower than that for dielectrophoresis, and hence the solution electric conductivity can be correctly measured without being affected by dielectrophoresis.

In the microparticle measuring apparatus of the invention, furthermore, the solution electric conductivity is calculated from an initial impedance value in a process in which dielectrophoresis is performed.

According to the configuration, the solution electric conductivity is calculated from an initial impedance value in the process in which dielectrophoresis is performed, and hence the solution electric conductivity can be rapidly measured.

In the microparticle measuring apparatus of the invention, furthermore, the control calculation unit corrects a result of the measurement in accordance with the solution electric conductivity.

According to the configuration, an influence of the solution electric conductivity can be avoided, or the influence can be quantitatively corrected.

In the microparticle measuring apparatus of the invention, furthermore, the control calculation unit has a detection lower-limit table which stores a detection lower limit corresponding to the solution electric conductivity.

Moreover, the microparticle measuring apparatus of the invention further includes notifying means for notifying the detection lower limit corresponding to the solution electric conductivity, to an outside.

According to the configuration, when the solution electric conductivity is lower than the detection lower limit, the user can know that the sensitivity and the accuracy are lowered.

The microparticle measuring apparatus of the invention includes: a cell into which a liquid containing microparticles is to be introduced; at least one pair of electrodes which are immersed in the cell; a migration power supply unit which applies an AC voltage of a frequency in a range of about 500 KHz to 10 MHz between the pair of electrodes; and a measurement calculation unit which measures the microparticles in the cell.

According to the configuration, an AC voltage of a frequency in the range of about 500 KHz to 10 MHz is applied between the pair of electrodes, whereby a sufficient dielectrophoretic force is caused to act irrespective of variation of the solution electric conductivity. Therefore, the number of the microparticles can be measured simply and at a sensitivity and accuracy which are necessary and sufficient, without performing pretreatment of reducing the solution electric conductivity.

The microparticle measuring method of the invention is a method in which an AC electric field is applied between a pair of electrodes which are immersed in a sample liquid containing microparticles, the microparticles are placed at a predetermined position by a dielectrophoretic force, and a concentration of the microparticles in the sample liquid is measured, wherein the method includes a step of setting a frequency of the AC electric field so that, even when a solution electric conductivity is changed, the dielectrophoretic force is equal to or larger than a predetermined value.

According to the configuration, the AC voltage of a frequency at which, even when the solution electric conductivity is changed, the dielectrophoretic force is equal to or larger than the predetermined value is applied between the pair of electrodes, whereby a sufficient dielectrophoretic force is caused to act irrespective of variation of the solution electric conductivity. Also in the case of a sample liquid having a high solution electric conductivity, therefore, the number of the microparticles can be measured simply and at a sensitivity and accuracy which are necessary and sufficient, without performing pretreatment of reducing the solution electric conductivity.

Moreover, the microparticle measuring method of the invention further has a step of, in a case where the frequency of the AC electric field is changed while the solution electric conductivity is set as a parameter, setting the frequency of the AC electric field so that the dielectrophoretic force is larger by about 50% or more than a maximum dielectrophoretic force in a case where the solution electric conductivity is lowest.

According to the configuration, it is possible to cause a dielectrophoretic force which is necessary and sufficient, to be applied to the microparticles, and the measurement can be performed simply and at a sensitivity and accuracy which are necessary and sufficient.

Moreover, the microparticle measuring method of the invention further has steps of: measuring the solution electric conductivity; and selecting the frequency of the AC electric field so that, even when the solution electric conductivity is changed, the dielectrophoretic force is equal to or larger than the predetermined value.

According to the configuration, a suitable frequency of the AC voltage can be selected for each solution electric conductivity. Therefore, the concentration of the microparticles can be measured simply and at a sensitivity and accuracy which are necessary and sufficient, without performing pretreatment of reducing the solution electric conductivity.

Moreover, the microparticle measuring method of the invention further has a step of correcting the concentration of the microparticles in the sample liquid by the measured solution electric conductivity.

According to the configuration, the concentration of the microparticles in the sample liquid is corrected by the measured solution electric conductivity, whereby, even when the solution electric conductivity is varied, a sensitivity and accuracy which are necessary and sufficient can be maintained.

Moreover, the microparticle measuring method of the invention further has a step of collecting the microparticles between the pair of electrodes by the dielectrophoretic force.

According to the configuration, the microparticles are collected between the gap of the pair of electrodes by the dielectrophoretic force, and hence the number of the microparticles can be measured rapidly, simply, and highly sensitively.

Moreover, the microparticle measuring method of the invention further has a step of measuring an impedance between the pair of electrodes.

According to the configuration, the concentration of the microparticles can be calculated from the time change of the impedance between the electrodes.

Moreover, the microparticle measuring method of the invention further includes steps of: measuring a capacitance between the pair of electrodes; and measuring a concentration of the microparticles in the sample liquid from a time change of the capacitance.

According to the configuration, the concentration of the microparticles in the sample liquid is measured from the time change of the capacitance, and hence the concentration of the microparticles can be measured rapidly, simply, and highly sensitively.

In the microparticle measuring method of the invention, furthermore, an electric conductivity of the sample liquid is in a range of 0 to 150 μS/cm.

According to the configuration, with respect to an oral sample which is most frequently measured, the concentration of the microparticles can be measured simply and at a sensitivity and accuracy which are necessary and sufficient.

The microparticle measuring method of the invention is a method in which an AC electric field is applied between a pair of electrodes which are immersed in a sample liquid containing microparticles, the microparticles are placed at a predetermined position by a dielectrophoretic force, and a concentration of the microparticles in the sample liquid is measured, wherein a frequency of the AC electric field is in a range of about 500 KHz to 10 MHz.

According to the configuration, an AC voltage of a frequency in the range of about 500 KHz to 10 MHz is applied between the pair of electrodes, whereby a sufficient dielectrophoretic force is caused to act irrespective of variation of the solution electric conductivity. Therefore, the concentration of the microparticles can be measured simply and at a sensitivity and accuracy which are necessary and sufficient, without performing pretreatment of reducing the solution electric conductivity.

### ADVANTAGES OF THE INVENTION

According to the invention, an AC voltage of a frequency at which a dielectrophoretic force on microparticles is equal to or larger than a predetermined value is applied between a pair of electrodes, whereby a sufficient dielectrophoretic force is caused to act irrespective of variation of a solution electric conductivity. Therefore, the number of the microparticles can be measured simply and at a sensitivity and accuracy which are necessary and sufficient, without performing pretreatment of reducing the solution electric conductivity.

### BRIEF DESCRIPTION OF DRAWINGS

FIG. 1 is a schematic configuration diagram (1) illustrating a microparticle measuring apparatus of a first embodiment of the invention.

FIG. 2 is a schematic view illustrating an electrode chip of the microparticle measuring apparatus of the embodiment of the invention.

FIG. 3 is a view showing lines of electric force 15 which are produced by a voltage applied between measurement electrodes 11a, 11b in the embodiment of the invention.

FIG. 4 is a diagram illustrating a manner in which microparticles 14 are trapped to opposing edge portions of the electrodes 11a, 11b along the lines of electric force.

FIG. 5 is a schematic diagram (2) illustrating the microparticle measuring apparatus of the first embodiment of the invention.

FIG. 6 is a schematic diagram (3) illustrating the microparticle measuring apparatus of the first embodiment of the invention.

FIG. 7 is a graph showing relationships of a solution electric conductivity (μS/cm) and Re[K] of the Clausius-Mossotti factor in the case where the frequency of a dielectrophoresis AC voltage is set as a parameter.

FIG. 8 is a graph (1) showing relationships of the frequency (Hz) of the dielectrophoresis AC voltage and the real part (Re[K]) of the Clausius-Mossotti factor.

FIG. 9 is a flowchart illustrating a microorganism measuring method of the first embodiment of the invention.

FIG. 10 is a schematic configuration diagram illustrating a microparticle measuring apparatus of a second embodiment of the invention.

FIG. 11 is a flowchart illustrating a microorganism measuring method of the second embodiment of the invention.

FIG. 12 is a view showing an equivalent circuit diagram between electrodes 30, 31, and phase relationships between a current 26 flowing through the equivalent circuit, and a voltage 27.

FIG. 13 is a view showing relationships of a voltage, current, and phase angle which are shown in a polar coordinate system on a complex plane.

FIG. 14 is a graph showing a dielectrophoretic force FDEP and a change of the inclination of a capacitance in the case where a solution electric conductivity is changed to the vicinity of 0 to 200 μS/cm.

FIG. 15 is a graph (2) showing relationships of the frequency (Hz) of the dielectrophoresis AC voltage and the real part (Re[K]) of the Clausius-Mossotti factor.

FIG. 16 is a graph for calculating the inclination of a time change of an electrostatic capacitance C between the flat plate electrodes 11a, 11b.

FIG. 17 is a schematic configuration diagram illustrating a microparticle measuring apparatus of a third embodiment of the invention.

FIG. 18 is a flowchart illustrating a microorganism measuring method of the third embodiment of the invention.

FIG. 19 is a view showing results of measurement of conductances of sample liquids of different electric conductivities.

FIG. 20 is a flowchart illustrating a microorganism measuring method of a fourth embodiment of the invention.

FIG. 21 is a graph showing measuring responses with respect to the microparticle concentration in a sample liquid in a fifth embodiment of the invention.

FIG. 22 is a graph showing values which were obtained by logarithm converting the concentration of Escherichia coil and a normalized capacitance inclination in Example 1 of the invention.

FIG. 23 is a graph showing results of measurements in the case where the frequency is 800 KHz in Example 1 of the invention.

FIG. 24 is a graph showing results of corrections using a conductivity correction table in Example 1 of the invention.

FIG. 25 is a graph showing values which are obtained by logarithm converting the concentration of cultivated bacteria and a normalized capacitance inclination in Example 2 of the invention.

### DESCRIPTION OF REFERENCE NUMERALS AND SIGNS

1 cell
2 sample liquid
3 electrode chip
4 migration power supply unit
5 measurement unit
6 control calculation unit
6a memory
7 conductivity inputting means
9 displaying means
10 substrate
11a, 11b, 20, 21 electrode
13 gap
14 microparticle
   15 line of electric force
17 stirring means
21 light source
22 light receiving portion
26 current
27 voltage
30, 31 electrode
32 capacitance
33 resistor
101 conductivity measuring means

### BEST MODE FOR CARRYING OUT THE INVENTION

### First Embodiment

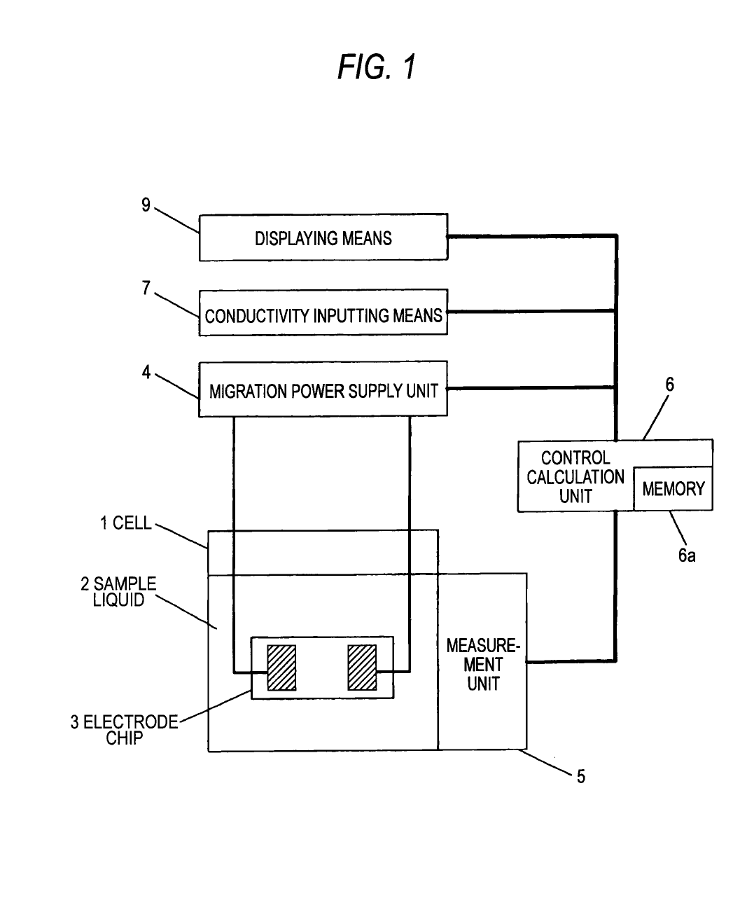

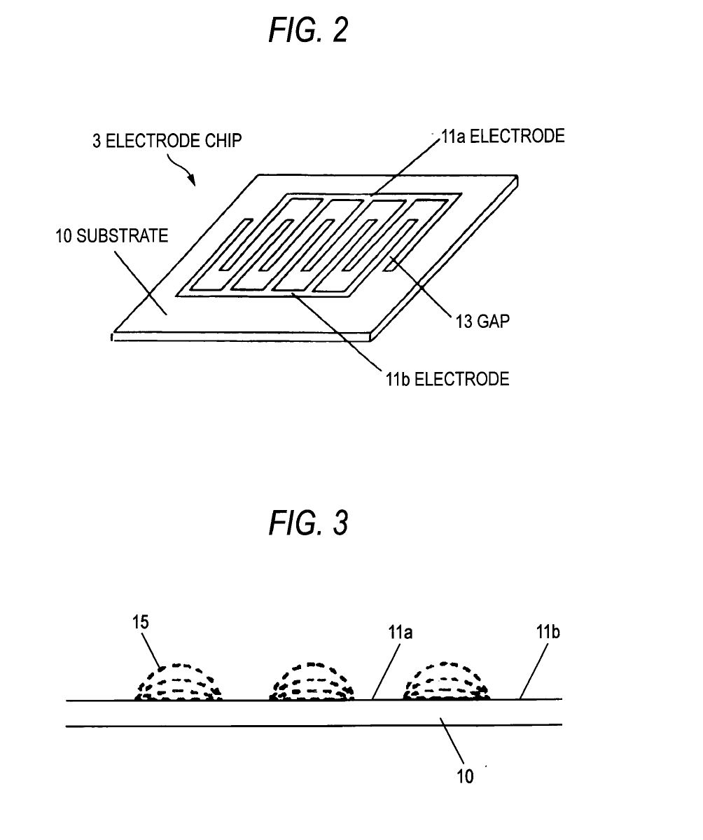

Hereinafter, a microorganism measuring apparatus of an embodiment of the invention will be described with reference to the drawings. FIG. 1 is a configuration diagram of the microorganism measuring apparatus of the embodiment, and FIG. 2 is a schematic view illustrating an electrode chip of the microorganism measuring apparatus of the embodiment.

Referring to FIG. 1, 1 denotes a cell which holds a sample liquid 2 containing microorganisms to be measured, 3 denotes an electrode chip including an electrode pair which collects the microorganisms by dielectrophoresis, 4 denotes a migration power supply unit, 5 denotes a measurement unit which measures a optical or electrical change caused by microorganisms that are trapped by dielectrophoresis, 6 denotes a control calculation unit which performs a control on the whole microorganism measuring apparatus, analysis calculation of measurement results, input/output processes, and the like, and 7 denotes conductivity inputting means for inputting the electric conductivity of the sample liquid 2.

Referring to FIG. 2, 10 denotes a substrate, 11a and 11b denote electrodes which are formed on the substrate 10, and which constitute a pair of poles, and 13 denotes an inter-electrode gap between the electrode 11a, 11b. On the substrate 10, patterns of the electrode 11a, 11b are formed by an electrically conductive material such as a metal. Examples of a preferred material are gold, silver, copper, aluminum, and platinum. Preferably, the material has a sufficient electric conductivity. In the embodiment, silver is used.

FIG. 3 shows lines of electric force 15 which are produced by a voltage applied between the measurement electrodes 11a, 11b. In the embodiment, the configuration in the vicinity of the gap 13 between the measurement electrodes 11a, 11b corresponds to an electric field concentrated portion. In the portion, the electric field is most concentrated in the gap 13. In the gap 13, therefore, the microorganisms are caused to migrate most strongly.

Preferably, each of the electrodes 11a, 11b is configured by a thin film which is sufficiently thin with respect to its width, and has a thickness of, for example, about 1,000 angstroms with respect to a width of 100 μm. According to the configuration, a non-uniform electric field is formed in an edge portion as viewed in the thickness direction, so that the microorganisms can be efficiently subjected to dielectrophoresis.

A method of patterning the electrodes 11a, 11b is requested to form a desired pattern with a selected material. A usual process which is used for forming an electrode, such as a method in which a metal thin film is formed by sputtering, vapor deposition, plating, or the like, and a pattern is formed by photolithography, laser processing, or the like, and that in which a pattern is directly formed by, for example, gravure printing, screen printing, or ink jet printing may be selected. The most adequate process may be selected in view of the productivity, the cost, and the like. In the embodiment, a thin film of silver is formed by sputtering, and a pattern is formed by photolithography.

The electrodes 11a, 11b are connected to the migration power supply unit 4. The migration power supply unit 4 applies an AC voltage of a specific frequency between the electrodes 11a, 11b. In the specification, the AC voltage means a sinusoidal voltage, or in addition a voltage in which the flow direction is changed in a substantially constant period, and average values of currents in both directions are equal to each other. As described later, the frequency applied by the migration power supply unit 4 is adequately determined by the control calculation unit 6.

In a state where the electrode chip 3 is immersed in the sample liquid 2 and the electrodes 11a, 11b are contacted with the sample liquid 2, when the AC voltage is applied between the electrodes 11a, 11b, the microorganisms contained the sample liquid 2 are captured by a dielectrophoretic force to the gap 13 interposed between the electrodes 11a, 11b.

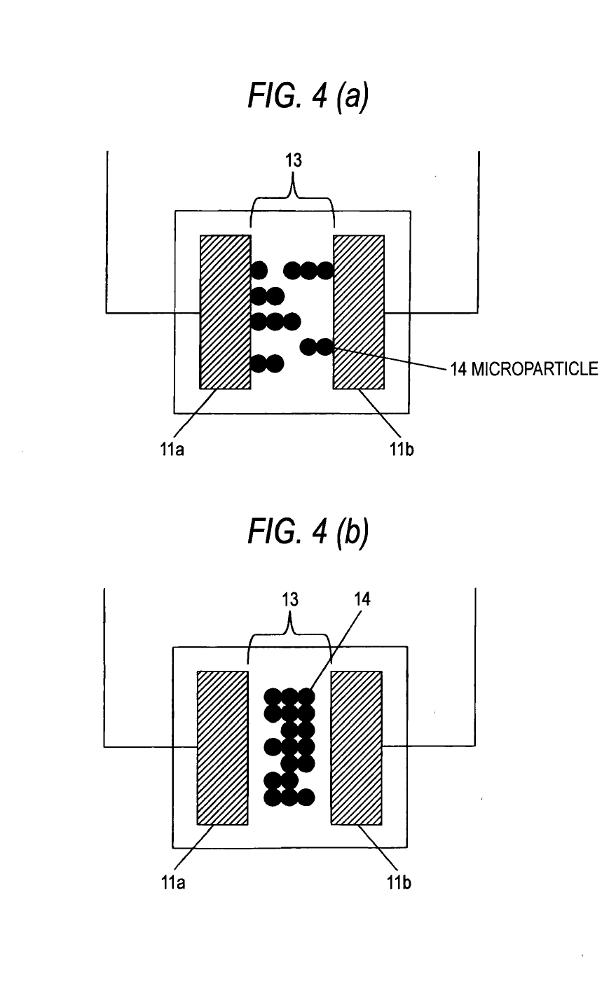

In the case where a positive dielectrophoretic force acts on the microorganisms, as shown in FIG. 4(a), the microorganisms 14 are trapped to the opposing edge portions of the electrodes 11a, 11b in the region of the gap 13 which is the electric field concentrated portion, along the lines of electric force in the bead string shape which is called a pearl chain.

By contrast, in the case where a negative dielectrophoretic force acts on the microorganisms 14, as shown in FIG. 4(b), the microparticles are trapped in the direction separating from the electric field concentrated portion, i.e., to the vicinity of the opposing center portions of the electrodes 11a, 11b in the region of the gap 13 which is the weak electric field portion.

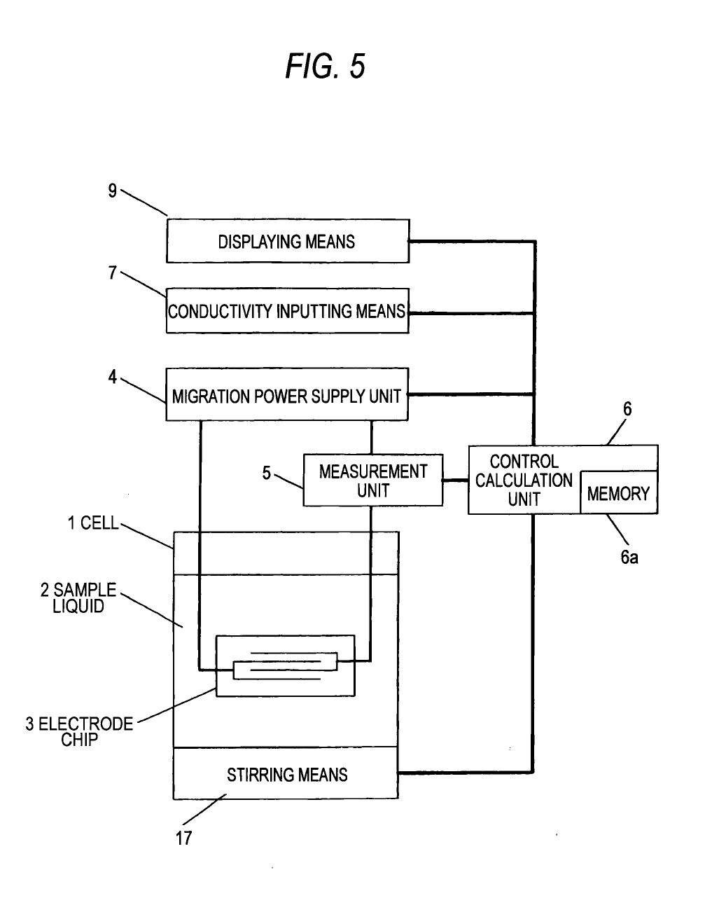

The measurement unit 5 measures an impedance change due to the microorganisms which are trapped to the gap 13 as described above. Specifically, as shown in FIG. 5, the measurement unit 5 configures a circuit which measures the impedance between the electrodes 11a, 11b, between the migration power supply unit 4 and the electrode chip 3.

In this case, the measurement unit 5 is configured by a circuit which measures the value of a current flowing between the electrodes 11a, 11b, and a phase difference between the voltage and current that are applied by the migration power supply unit 4, and the like. The measurement unit 5 measures changes of the current between the electrodes 11a, 11b, and the phase difference which are caused by a phenomenon in which the microorganisms are moved by dielectrophoresis to be concentrated in the vicinity of the electric field concentrated portion.

The current value and phase difference which are measured by the measurement unit 5 are passed to the control calculation unit 6. The control calculation unit 6 calculates the value of the impedance between the electrodes 11a, 11b from the current, the phase difference, and information of the voltage and frequency which are applied by the migration power supply unit 4.

When the region which is between the electrodes 11a, 11b, and which is filled only with the sample liquid 2 is replaced with the microorganisms of a different permittivity by trapping due to dielectrophoresis, the impedance between the electrodes 11a, 11b is changed in accordance with the number of the trapped microorganisms.

Therefore, the number of the microorganisms trapped to the gap 13 can be estimated from the difference or in other words, from the change amount between the impedance value at a certain time and the initial impedance value immediately after the application of the voltage. The number of the trapped microorganisms depends on the concentration of the microorganisms contained in the sample liquid. Therefore, it is possible to measure the number of the microorganisms in the sample liquid.

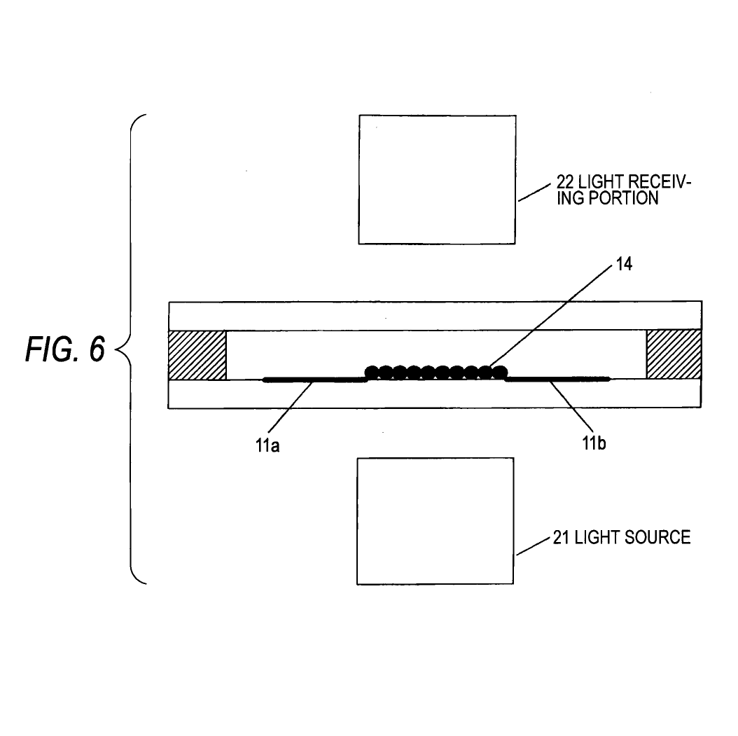

As shown in FIG. 6, the measurement unit 5 can be realized also by optical measuring means. In this case, the cell 1 is placed in a positional relationship in which the gap 13 is included in an optical path between a light source 21 and a light receiving portion 22. By using a phenomenon in which the amount of light incident on the light receiving portion 21 is changed in accordance with the number of the microorganisms trapped to the gap 13, it is possible to estimate the number of the microorganisms trapped to the gap 13.

Alternatively, information of the light receiving portion 22 may be passed to the control calculation unit 6 to be converted to an image, and the control calculation unit 6 may directly calculate the number of particles by using a particle determination algorithm or the like, or may convert the information to the number of microparticles by obtaining a microparticle area with respect to the view field area. The number of the microorganisms trapped to the gap 13 and obtained in this way depends on the concentration of the microorganisms contained in the sample liquid. Therefore, it is possible to measure the number of the microorganisms in the sample liquid.

In order to trap the microorganisms to the gap 13, as described above, it is necessary to induce a dielectrophoretic force which is sufficiently large with respect to all external forces acting on the microorganisms other than dielectrophoresis, such as the viscous force, the gravitation, and the Brownian motion. When the force is insufficient, the number of microorganisms which can be measured by the measurement unit 5 is reduced, and hence the measurement sensitivity and accuracy are remarkably lowered. When the signal level is lower than that which can be measured by the measurement unit 5, the measurement of microorganisms cannot be performed.

In the embodiment, therefore, the control calculation unit 6 adequately determines a frequency at which a dielectrophoretic force that is sufficient for trapping microorganisms to the gap 13 acts, and the migration power supply unit 4 applies a voltage of the determined frequency. This enables a signal which can be sufficiently detected by the measurement unit 5, to be taken out. Therefore, the concentration of the microorganisms can be measured highly accurately and highly sensitively.

The control calculation unit 6 is configured by a CPU which is not shown, and circuits such as a memory 6a which stores programs defining the series of operations, and various data, and controls the series of measurement operations. The conductivity inputting means 7 is configured so that the electric conductivity of the sample liquid can be input before measurement. For example, the means can be realized by a method in which a numerical value is input through a numerical keypad, or that in which one of switches respectively corresponding to a plurality of conductivity ranges such as “0 to 50 μS/cm” and “50 to 100 pS/cm” is pressed.

The memory 6a has a frequency selection table for selecting an adequate frequency of the voltage applied by the migration power supply unit 4 from the value of the electric conductivity of the sample liquid and given from the conductivity inputting means 7. In the frequency selection table, the optimum frequency and value of the applied voltage at which a sufficient dielectrophoretic force acts on the microorganisms are stored for each electric conductivity of the sample liquid 2 in the form of a table.

Here, the frequency selection table stored in the memory 6a will be described in detail. As shown in Table 2, at least the electric conductivity of the sample liquid, and the amplitude and optimum frequency of the applied AC voltage are stored in the frequency selection table while being correlated with each other. The table may be prepared while setting a specific numerical value or a certain range as the electric conductivity of the sample liquid. The control calculation unit 6 selects the amplitude and optimum frequency of the AC voltage corresponding to the given electric conductivity. In the frequency corresponding to the electric conductivity of 300 μS/cm or more, “E” indicates that an error occurs, and also that, when the electric conductivity is excessively high, the measurement cannot be performed.

TABLE 2

| Conductivity of sample liquid | | |
|---|---|---|
| (μS/cm) | Voltage (Vpp) | Frequency (kHz) |
| 1 - | 10 | 280 |
| 5 - | 10 | 700 |
| 10 - | 10 | 1,000 |
| 20 - | 10 | 1,500 |
| 50 - | 10 | 2,100 |
| 100 - | 10 | 3,000 |
| 200 - | 10 | 4,400 |
| 300 - | 10 | E |

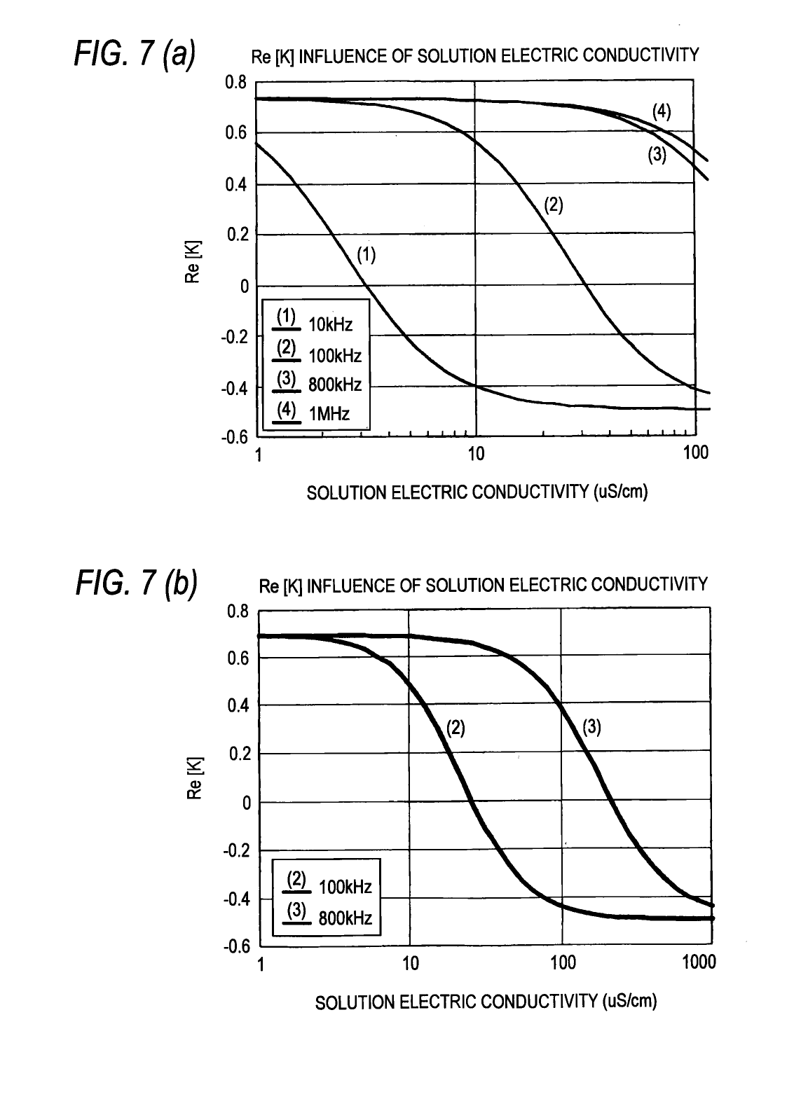

Next, the optimum frequency will be described. In (Exp. 1), the dielectrophoretic force FDEP is proportional to the real part of the Clausius-Mossotti factor, i.e., Re[K]. As apparent from (Exp. 2) and (Exp. 3), Re[K] depends on the electric conductivity of the sample liquid 2. FIG. 7 shows how Re[K], i.e., the dielectrophoretic force changes when the electric conductivity of the sample liquid 2 is changed.

In FIG. 7, Re[K] is shown as a function of the electric conductivity of the sample liquid 2 while the electric field used in dielectrophoresis, or in other words the frequency of the applied voltage is set as a parameter. Re[K] corresponds to the dielectrophoretic force FDEP, and the positive and negative of the force correspond to the phenomenon in which the dielectrophoretic force functions as an attractive force, and that in which the dielectrophoretic force functions as a repulsive force, respectively.

As shown in FIG. 7(a), in the case where the frequency of the dielectrophoresis AC voltage is (1) 10 KHZ, for example, Re[K] is changed from positive to negative in the vicinity of the solution electric conductivity of 3 μS/cm, and the dielectrophoretic force FDEP acting on the microparticles is changed from an attractive force to a repulsive force.

By contrast, in the case where the frequency of the dielectrophoresis AC voltage is (2) 100 KHZ, Re[K] is changed from positive to negative in the vicinity of the solution electric conductivity of 30 μS/cm, and the dielectrophoretic force FDEP acting on the microparticles is changed from an attractive force to a repulsive force.

FIG. 7(b) shows changes of the dielectrophoretic force FDEP when the solution electric conductivity is changed from 1 μS/cm to 1,000 μS/cm in the case where the frequency of the dielectrophoresis AC voltage is (2) 100 KHz and (3) 800 KHz. In the case where the frequency is (2) 100 KHz, Re[K]<0 when about 20 μS/cm or more. However, the reduction of the dielectrophoretic force with respect to the increase of the electric conductivity is suppressed at 800 KHz, and Re[K]>0 until about 250 μS/cm, so that trapping to the edge portions in the gap 13 can be performed by an attractive force.

This shows that the optimum frequency exists at which the reduction of the dielectrophoretic force is smallest with respect to the increase of the electric conductivity of the sample liquid. The optimum frequency may be determined by performing the following experiment. Namely, a plurality of sample liquids having the same microparticle concentration and different electric conductivities are prepared, and the measurement is performed on each of the sample liquids while the frequency of the applied voltage is changed. As a result, the frequency at which the measuring response is largest is set as the optimum frequency for the sample liquid. The optimum frequencies shown in Table 2 are determined in this way.

When the frequency is excessively high, however, a measurement circuit is hardly realized, and when the frequency is excessively low, a convection flow due to Joule heat, or in an extreme case generation of bubbles due to electrolysis adversely affects the measurement. As the optimum frequency, therefore, there is a frequency in an allowable range where it is not optimum for dielectrophoresis, but can cause dielectrophoresis sufficient for performing the microparticle measurement.

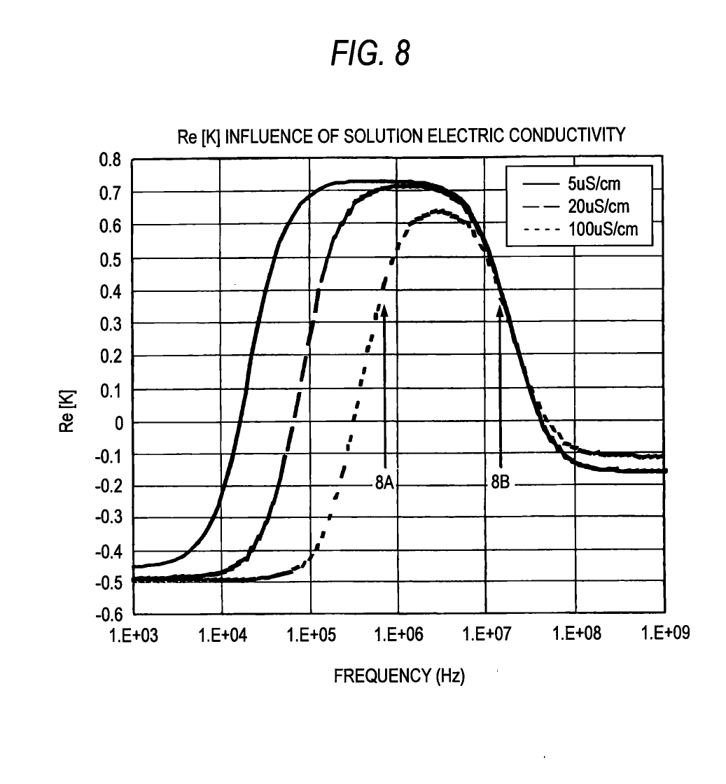

FIG. 8 is a graph showing relationships of the frequency (Hz) of the dielectrophoresis AC voltage and the real part (Re[K]) of the Clausius-Mossotti factor in the case where the solution electric conductivity (μS/cm) is set as a parameter. In the case where the microparticle measurement is performed by using positive dielectrophoresis at the sample liquid electric conductivity of 100 μS/cm, when a sufficient dielectrophoretic force by which a measuring response can be obtained is Re[K]>0.4, the optimum frequency is about 700 KHz to 4 MHz. In this case, in order to avoid the measurement circuit from being complicated because of the high frequency, 700 KHz which is the lower-limit frequency may be employed as the optimum frequency.

Furthermore, there is a case where, in the range of the sample liquid electric conductivity which must be measured, a sufficient dielectrophoretic force is obtained at one specific frequency. In this case, a frequency selection table such as shown in Table 3 is used.

TABLE 3

| Conductivity of sample liquid | | |
|---|---|---|
| (μS/cm) | Voltage (Vpp) | Frequency (KHz) |
| 1~ | 10 | 800 |
| 300~ | 10 | E |

In the case where the range of the sample liquid electric conductivity which must be measured is 0 to 100 μS/cm, when the frequency is 800 KHz, for example, Re[K]>0.4 in the whole electric conductivity range, and the measurement can be performed at a single frequency in a desired sample liquid electric conductivity range. Therefore, the circuit configuration is simplified, and this is convenience. In this case, when the sample liquid electric conductivity exceeds 100 μS/cm, data corresponding to an error are written as shown in the frequency selection table.

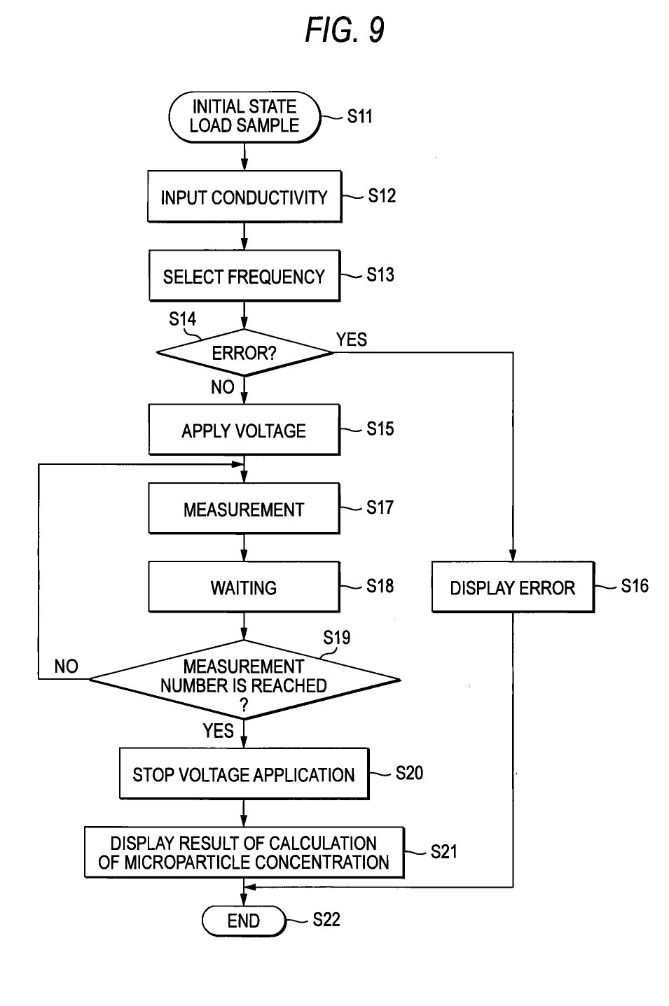

FIG. 9 is a flowchart illustrating the microorganism measuring method of the embodiment. Hereinafter, a series of flows from introduction of a sample to condensation of microorganisms in the cell 1, the measurement, and showing a result will be described with reference to the flowchart. First, in an initial state, a sample liquid containing microorganisms which are to be measured is loaded into the cell 1 (step S11).

Next, the electric conductivity of the loaded sample liquid is input through the conductivity inputting means 7. The input electric conductivity is passed to the control calculation unit 6 (step S12).

The control calculation unit 6 to which the electric conductivity of the sample liquid is passed refers the optimum frequency table provided in the memory 6a, and selects the amplitude value and frequency of the voltage to be applied to the electrodes (step S13). As the voltage amplitude value (hereinafter, referred to as “voltage for dielectrophoresis”) at this time, a sufficient value for trapping the microorganisms to the gap 13 may be selected. In the embodiment, the voltage for dielectrophoresis is set to 10 Vp-p.

In Tables 2 and 3, the voltage for dielectrophoresis is set to a value which is constant with respect to the electric conductivity. The optimum value may be selected for each electric conductivity. In the case where the electric conductivity is high, when the voltage is excessively high, for example, Joule heat is generated, and the microorganism trap due to dielectrophoresis is affected. Therefore, for example, the voltage for dielectrophoresis is further lowered as the electric conductivity is higher.

Next, the control calculation unit 6 determines whether the frequency which is stored in the memory, and which corresponds to the input electric conductivity is an error code (E) or not (step S14). If the frequency is the error code (E), the process advances to step S16, the control calculation unit 6 instructs that the situation where the input electric conductivity is outside the measurement range is displayed on displaying means 9, and the measurement is ended (step S22).

If it is determined in step S14 that the selected frequency is not the error code (E), the control calculation unit 6 controls the migration power supply unit 4 so as to apply a voltage between the electrodes 11a, 11b at the voltage amplitude and frequency which are selected in the optimum frequency table (step S15).

When the predetermined voltage is applied between the electrodes 11a, 11b, the measurement unit 5 immediately measures the impedance between the electrodes 11a, 11b as data in the initial state immediately after the application of the voltage. The measurement result is passed to the control calculation unit 6, and stored as the initial impedance value into the memory 6a (step S17).

Here, impedance measurement is described as an example. In the case where the measurement unit 5 measures the state of the gap 13 by using optical means, the initial state can be measured even when a voltage is not applied, and hence step S17 may be performed before step S15.

Next, the control calculation unit 6 waits until a predetermined time period elapses, by using time counting means which is not shown. At this time, the migration power supply unit 4 is maintained to hold the voltage application (step S18).

After an elapse of the predetermined time period, the control calculation unit 6 determines whether a predetermined measurement number is reached or not (step S19), and, if the number is not reached, the process returns to step S17. When the process returns to step S17, the control calculation unit 6 instructs the measurement unit 5 so as to measure the impedance between the electrodes 11a, 11b, and a result of the measurement is stored into the memory 6a as a result after the elapse of the predetermined time period.

If the predetermined measurement number is reached, the control calculation unit 6 instructs the migration power supply unit 4 so as to stop the voltage application (step S20).

After the voltage application is stopped, the control calculation unit 6 calculates the microparticle concentration in the sample liquid 2 from temporal change data of the impedance between the electrodes 11a, 11b, and stored in the memory 6a, and controls the displaying means 9 so as to display a result (step S21), and the series of measurement operations is ended (step S22).

The calculation of the microorganism concentration can be obtained from a calibration curve which is previously stored in the memory 6a. The calibration curve uses a function showing a curve which is obtained by previously measuring a calibration sample in which the microorganism concentration is known, by using the measurement system of the microorganism measuring apparatus that is described in the embodiment, and performing regression analysis on dispersions from correlationships of the number of microorganisms at this time and the impedance change.

The conversion expression is stored into the memory 6a of the control calculation unit 6. In the case where a sample in which the microorganism concentration is not known is to be measured, when the value of an impedance change in a predetermined time period is substituted, the microorganism concentration in the cell 1 can be calculated. In the case where a conversion table is used, calculation results obtained by the conversion expression are previously stored.

As described above, according to the embodiment, the optimum frequency of the applied electric field is selected in accordance with the electric conductivity of the sample liquid, so that the dielectrophoretic force which is sufficient for performing the measurement can act on microorganisms. Even when the electric conductivity of the sample liquid is increased, therefore, the microorganisms can be measured without performing pretreatment.

### Second Embodiment

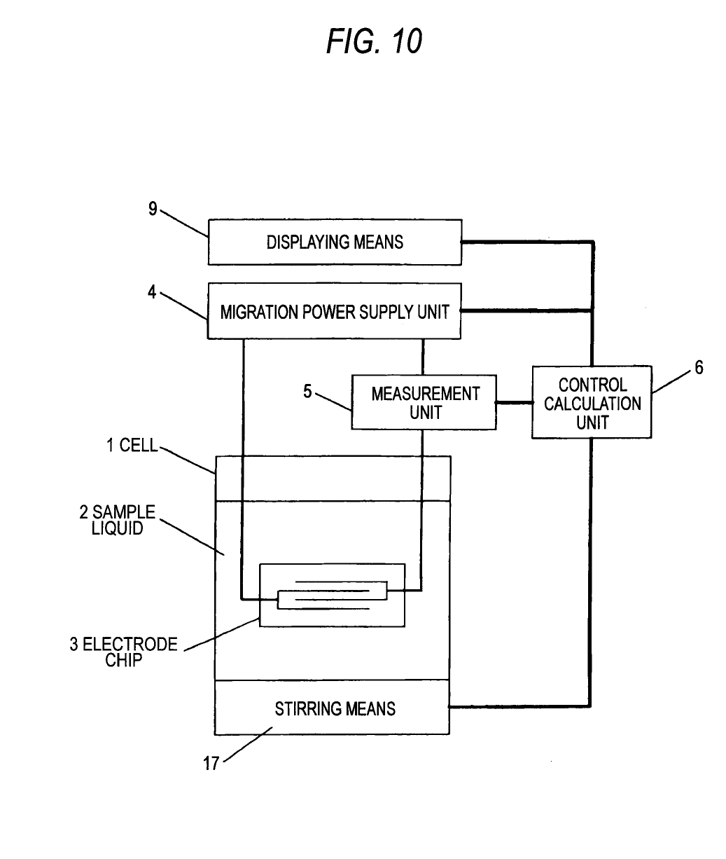

Hereinafter, a microorganism measuring apparatus of an embodiment of the invention will be described with reference to the drawings. FIG. 10 is a configuration diagram of the microorganism measuring apparatus of the embodiment.

Referring to FIG. 10, 1 denotes a cell which holds a sample liquid 2 containing microorganisms to be measured, 3 denotes an electrode chip including an electrode pair which collects the microorganisms by dielectrophoresis, 4 denotes a migration power supply unit, 5 denotes a measurement unit which measures the inter-electrode impedance, and 6 denotes a control calculation unit which performs a control on the whole microorganism measuring apparatus, calculations such as an impedance calculation, and the like.

As shown in FIG. 2, 10 denotes a substrate, and 11a and 11b denote electrodes which are formed on the substrate 10, and which constitute a pair of poles. On the substrate 10, patterns of the electrode 11a, 11b are formed by an electrically conductive material such as a metal. Preferably, each of the electrodes 11a, 11b is configured by a thin film which is sufficiently thin with respect to its width, and has a thickness of, for example, about 1,000 angstroms with respect to a width of 100 μm. According to the configuration, a non-uniform electric field is formed in an edge portion as viewed in the thickness direction, so that the microorganisms can be efficiently subjected to dielectrophoresis. In the embodiment, the substrate 10 is separated from the cell 1. Alternatively, the substrate 10 may be formed as a part of the wall face of the cell 1 to be integrated therewith.

The plane patterns of the electrodes 11a, 11b are patterned to a shape which can collect the microorganisms in a gap 13 therebetween by dielectrophoresis, and efficiently measure an impedance change due to the collected microorganisms. Specifically, as shown in FIG. 2, for example, one of most preferred shapes is a so-called interdigitated array (IDA) in which opposed portions of the electrodes 11a, 11b have a nested structure.

In order to efficiently collect microorganisms, the area of the portion of the gap 13 must be increased to enhance the probability that microorganisms are collected to the electrodes. When the distance of the gap 13 is increased, however, the electric field intensity is lowered when the same voltage is applied between the electrodes 11a, 11b, and the dielectrophoretic force is weakened, with the result that microorganisms cannot be efficiently collected. Therefore, it is preferable that the distance of the gap 13 is narrowed to, for example, about 1 to 100 μm.

In order to efficiently collect microorganisms, it is effective that the electrode pattern is elongated in the length direction of the opposed portions where the electrodes 11a, 11b are opposed to each other, and preferably the pattern is, for example, about 20 to 1,000 mm. At this time, the electrode plane pattern is formed into a shape of IDA, whereby the opposed portions can be substantially prolonged, and the electrodes can be integrated into a minute area, so that there is a merit that the electrode chip 3 can be miniaturized.

The above is an example of the design of the electrodes. Preferably, an optimum combination of the distance of the gap 13, the length of the opposed portion, and the thickness and pattern of the electrodes is selected in accordance with the voltage to be applied between the electrodes 11a, 11b and the size of microorganisms.

The electrode chip 3 is immersed in the cell 3 which holds the sample liquid 2 containing microorganisms, and electrically connected to the migration power supply unit 4 and the measurement unit 5. Stirring means 17 such as a magnetic stirrer can be disposed in the cell 1.

When the sample liquid 2 is stirred in the cell 1, the microorganism concentration in the sample liquid 2 can be made uniform, and many microorganisms can be guided into the gap 13 between the electrodes 11a, 11b. Therefore, microorganisms can be collected more efficiently in the gap 13, and shortening of the measurement time period and improvement of the measurement sensitivity are enabled.

In the case where the cell 1 is configured as a microchamber by disposing a spacer, a lid, and the like on the electrode chip 3, the stirring means 17 may be realized as a closed flow path having a circulation flow path including the microchamber. A similar effect as the stirring by the magnetic stirrer can be attained by circulating the sample liquid on the electrode chip 3 in the microchamber by a peristaltic pump or the like.

The migration power supply unit 4 applies an AC voltage for performing dielectrophoresis, between the electrodes 11a, 11b. Therefore, the microorganisms are caused to perform dielectrophoresis to be collected to the gap 13 between the electrodes 11a, 11b, by the non-uniform electric field which is induced between the electrodes 11a, 11b. In the specification, the AC voltage means a sinusoidal voltage, or in addition a voltage in which the flow direction is changed in a substantially constant period, and average values of currents in both directions are equal to each other.

The measurement unit 5 performs measurements which are necessary for calculating the impedance between the electrodes 11a, 11b. Specifically, the measurement unit 5 is configured by a circuit which measures the value of a current flowing between the electrodes 11a, 11b, and a phase difference between the voltage and current that are applied by the migration power supply unit 4, and the like. The measurement unit 5 measures changes of the current between the electrodes 11a, 11b, and the phase difference which are caused by a phenomenon in which the microorganisms are moved by dielectrophoresis to be concentrated in the vicinity of the electric field concentrated portion. The current value and phase difference which are measured by the measurement unit 5 are passed to the control calculation unit 6.

The control calculation unit 6 is configured by a microprocessor which is not shown, a memory which stores programs, a data table, and the like which are preset, a timer, and the like, and controls the migration power supply unit 4 in accordance with the programs and the data tables. In accordance with the control of the control calculation unit 6, the migration power supply unit 4 applies an AC voltage which has a specific frequency and voltage, between the electrodes 11a, 11b.

Moreover, the control calculation unit 6 transmits and receives signals to and from the measurement unit 5, and receives data of the current value and phase difference which are measured by the measurement unit 5. From the data of the voltage, the current, the phase difference, and the frequency, the control calculation unit 6 calculates the impedance between the electrodes 11a, 11b, and sequentially stores results into the memory.

The control calculation unit 6 performs the series of measurement operations at constant time intervals in accordance with the preset programs, and, when a predetermined time period elapses, controls the migration power supply unit 4 to stop the voltage application between the electrodes 11a, 11b. Thereafter, the measurement operations are ended.

From the results of the impedance measurement stored in the memory, next, the control calculation unit 6 calculates the inclination of the time change of the impedance. For each of the given voltages and frequencies, and the kinds of microorganisms, calibration curve data are stored in the data table in the memory. The control calculation unit 6 compares the calculated inclination of the time change of the impedance, with the calibration curve to calculates the concentration of microorganisms contained in the sample liquid, and performs, for example, storage of results into the memory, or displaying the results on the displaying means 9 such as an LCD.

In the embodiment, the measurement results are displayed in the form of the microorganism concentration. In the case where the capacity of the sample liquid is previously defined, alternatively, results may be displayed after conversion to the number of microorganisms. The user can directly know the measured microorganism number, as the microorganism number per 1 ml of the sample. Alternatively, the displaying means 9 may display result in another displaying method in accordance with the object, for example, larger or smaller.

In the case where the user is not required to directly know the microorganism number and the microorganism number may be known in order to control an arbitrary apparatus including the microparticle measuring apparatus, such as the case where the number of microorganisms in the sample is checked and a sterilizer is controlled, or cultivation conditions such as the temperature are controlled, it is a matter of course that the displaying means is not particularly required to be disposed.

As shown in FIG. 3, lines of electric force 15 are produced by a voltage applied between the measurement electrodes 11a, 11b. In the embodiment, the configuration in the vicinity of the gap 13 between the measurement electrodes 11a, 11b corresponds to an electric field concentrated portion. In the portion, the electric field is most concentrated in the gap 13. In the gap 13, therefore, the microorganisms are caused to migrate most strongly.

As shown in FIG. 2, the gap 13 is a portion which is interposed between the parallel measurement electrodes 11a, 11b, and the electric field distribution is uniform in the direction along which the electrodes are elongated, i.e., that perpendicular to the plane of the sheet of FIG. 3 which shows sections of the measurement electrodes 11a, 11b. In the direction perpendicular to the surface of the substrate 10 (in the direction parallel to the plane of the sheet), however, the electric field distribution such as shown in FIG. 3 is produced, and the electric field is most concentrated in the plane defined by connecting the edge lines of the electrodes to each other.

Microorganisms floating in the vicinity of the gap 13 are attracted toward the gap 13 by the function of the electric field produced between the electrodes 11a, 11b, and aligned along the electric force lines 15. At this time, the moving state of microorganisms in the vicinity of the gap 13 depends on the number of microorganisms existing in the sample liquid and the distance of the gap 13. When the microorganism number is sufficiently large, a situation where the gap 13 is bridged by a chain configured by microorganisms occurs.

In this case, microorganisms which originally float in the vicinity of the gap 13 are immediately moved to the portion of the gap 13, and those which float in portions separated from the gap 13 reach the portion of the gap 13 after elapses of predetermined time periods that depend on the their distances, respectively. Therefore, the number of microorganisms which are collected in a predetermined region in the vicinity of the gap 13 is proportional to the number of microorganisms in the measurement cell 1. Naturally, this is proportional also to the number of microorganisms existing in the sample liquid.

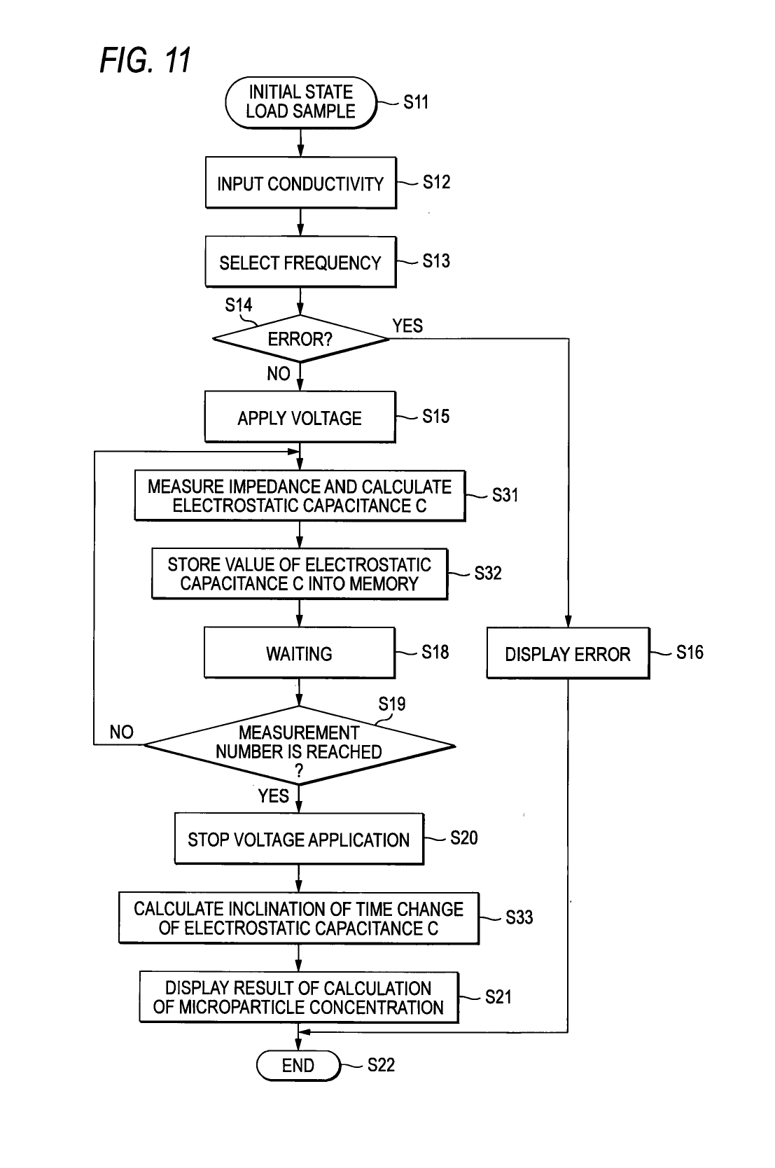

FIG. 11 is a flowchart illustrating a microorganism measuring method of the embodiment. Hereinafter, a series of flows from introduction of a sample to condensation of microorganisms in the cell 1, the measurement, and washing will be described with reference to the flowchart. However, the description of the portions which are similar to those of Embodiment 1 is omitted.

After the voltage is applied in step S15, the measurement unit 5 measures the current flowing between the electrodes 11a, 11b, and sends a result of the measurement to the control calculation unit 6. As described below, the control calculation unit 6 calculates, from the applied voltage and the measured current, the impedance between the electrodes 11a, 11b, and the electrostatic capacitance C in the case where an equivalent circuit assumed between the electrodes 11a, 11b is deemed as a CR parallel circuit configured a resistance R and electrostatic capacitance C which will be described later (step S31).

The impedance can be calculated by a division of the applied voltage and the current. The electrostatic capacitance C can be calculated together with the resistance R by substituting the values of the reactance and the resistance into an expression indicating the combined impedance of the assumed CR parallel circuit, and then solving simultaneous equations. The values of the reactance and the resistance are calculated by using the impedance and the value (hereinafter, referred to as the phase angle) in which the phase difference between the voltage and the current is expressed by the angle difference of the angular frequencies.

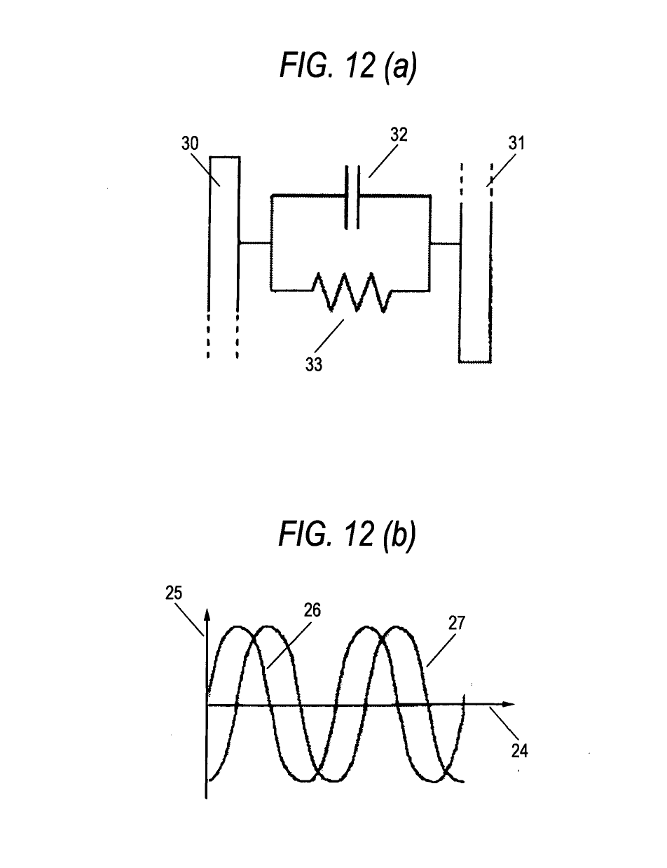

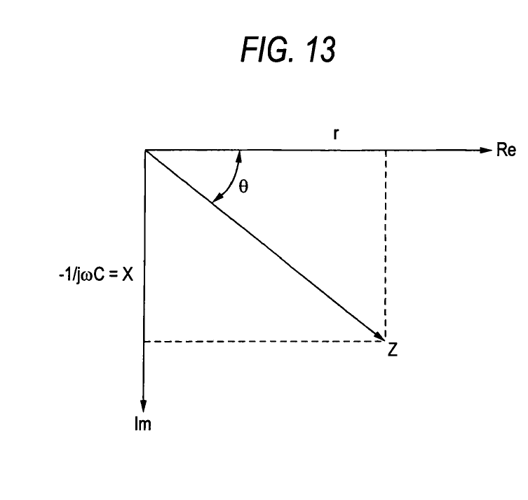

Hereinafter, the impedance Z, the electrostatic capacitance C, the reactance x, and the resistance r will be described in detail with reference to FIGS. 12 and 13 and the expressions of (Exp. 4) to (Exp. 8).

$$\begin{matrix}Z = \frac{R - j ω {R}^{2} C}{1 + {ω}^{2} {R}^{2} {C}^{2}} & [ Exp . 4 ] \\ r = \frac{R}{1 + {ω}^{2} {R}^{2} {C}^{2}} & [ Exp . 5 ] \\ x = \frac{- ω {R}^{2} C}{1 + {ω}^{2} {R}^{2} {C}^{2}} & [ Exp . 6 ] \\ R = r + \frac{{x}^{2}}{r} & [ Exp . 7 ] \\ C = \frac{x}{ω ( {r}^{2} + {x}^{2} )} & [ Exp . 8 ]\end{matrix}$$

(Exp. 4) is an expression indicating the combined impedance Z of the CR parallel equivalent circuit, (Exp. 5) is an expression indicating the resistance r of the CR parallel equivalent circuit, (Exp. 6) is an expression indicating the reactance x of the CR parallel equivalent circuit, (Exp. 7) is an expression indicating the resistance R of the CR parallel equivalent circuit, and (Exp. 8) is an expression indicating the electrostatic capacitance C of the CR parallel equivalent circuit.

FIG. 12(a) shows the electric state between electrodes 30, 31 in the form of an equivalent circuit. Water containing microorganisms exists between the electrodes 30, 31. It is seemed that, before the microorganisms are moved into the gap between the electrodes by dielectrophoresis, an electrostatic capacitance C32 configured while the water is set as an inter-electrode dielectric, and the electrical conduction resistance R33 connect in parallel the electrode 30 and the electrode 31.

Also after the microorganisms are moved by dielectrophoresis, the microorganisms act as dielectric microparticles as described later. Therefore, it is seemed that, even when the absolute values of the electrostatic capacitance C32 and the resistance R33 are changed, the connection form of the equivalent circuit is unchanged. Hereinafter, the equivalent circuit is referred to as the CR parallel circuit.

It is usually known that, when an AC voltage is applied to such a CR parallel circuit, a phase difference appears between a current 26 flowing through the circuit, and an applied voltage 27 as shown in FIG. 12(b). When the reactance component x is a function of the angular frequency ω, the combined impedance Z with the resistance component r can be expressed as a vector having the resistance component r and a phase angle θ as shown in FIG. 13.

The impedance Z is obtained by a division of the applied voltage and the current which are measured, and corresponds to the absolute value of the vector shown in FIG. 13. At this time, the impedance Z is expressed in the form of Z=r+jx (j is the imaginary unit). The resistance r is correlated with the resistance component of the combined impedance of the CR parallel circuit which is shown as r=Z sin θ in FIG. 12(a), and the reactance x is correlated with the inverse of the capacitance component of the circuit in which x=Z cos θ.

By contrast, the combined impedance of the CR equivalent circuit of FIG. 12(a) is expressed by (Exp. 4). When (Exp. 4) is decomposed into the resistance r and the reactance x from the relationship of Z=r+jx, (Exp. 5) and (Exp. 6) are obtained. When (Exp. 5) and (Exp. 6) are used as simultaneous expressions and then deformed, (Exp. 7) and (Exp. 8) are obtained. When r, x, and w which are calculated from the voltage value for measurement, the current value at the time, and the measurement value of the phase angle of the voltage and the current are substituted into (Exp. 7) and (Exp. 8), it is possible to know the resistance R33 and the electrostatic capacitance C32.

In the above description, the calculations seem to be very cumbersome. However, the control calculation unit 6 includes the microprocessor which is not shown, and hence the series of calculations are ended in a moment.

The control calculation unit 6 stores the value of the calculated electrostatic capacitance C as an initial value into the memory (step S32), and waits until the next impedance measurement timing occurs. Then, the migration power supply unit 4, the measurement unit 5, and the control calculation unit 6 adequately exchange signals as required to perform smooth operations in accordance with the preset programs.

Alternatively, calculations corresponding to measurement values may be previously performed, and the results may be formed into a table and stored into the memory. According to the configuration, even when the calculations are not performed for each measurement, the measurement value can be converted to the microparticle number simply by referring the table. Namely, the concentration of microorganisms is performed by dielectrophoresis for a preset time period, the measurement is then performed, the voltage value for measurement, the current value at the time, and the phase difference of the voltage and the current are measured, and thereafter the table in the memory is referred by using the three values. The microorganism number which is previously calculated is written in the table. According to the configuration, a microorganism measuring apparatus which can rapidly perform the measurement, and which has a further simplified structure can be obtained without disposing the control calculation unit 6.

When the frequency of a dielectrophoresis AC voltage is set as a parameter, the relationships between the solution electric conductivity (μS/cm) and the real part (Re[K]) of the Clausius-Mossotti factor are as shown in FIG. 7. Re[K] corresponds to the dielectrophoretic force FDEP, and the positive and negative of the force correspond to the phenomenon in which the dielectrophoretic force functions as an attractive force, and that in which the dielectrophoretic force functions as a repulsive force, respectively.

As shown in FIG. 7(a), in the case where the frequency of the dielectrophoresis AC voltage is (1) 10 KHZ, for example, Re[K] is changed from positive to negative in the vicinity of the solution electric conductivity of 3 μS/cm, and the dielectrophoretic force FDEP acting on the microparticles is changed from an attractive force to a repulsive force.

By contrast, in the case where the frequency of the dielectrophoresis AC voltage is (2) 100 KHZ, Re[K] is changed from positive to negative in the vicinity of the solution electric conductivity of 30 μS/cm, and the dielectrophoretic force FDEP acting on the microparticles is changed from an attractive force to a repulsive force.

FIG. 7(b) shows changes of the dielectrophoretic force FDEP when the solution electric conductivity is changed from 1 μS/cm to 1,000 μS/cm in the case where the frequency of the dielectrophoresis AC voltage is (2) 100 KHz and (3) 800 KHz.

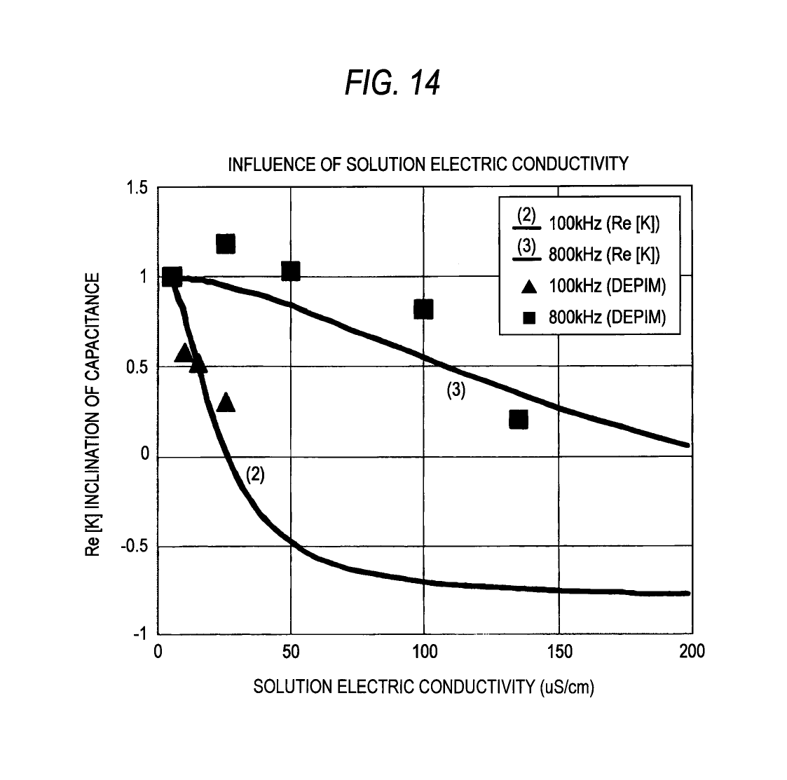

FIG. 14 shows changes of the dielectrophoretic force FDEP and a change of the inclination of the capacitance when the solution electric conductivity is changed from the vicinity of 0 μS/cm to 200 μS/cm in the case where the frequency of the dielectrophoresis AC voltage is (2) 100 KHz and (3) 800 KHz.

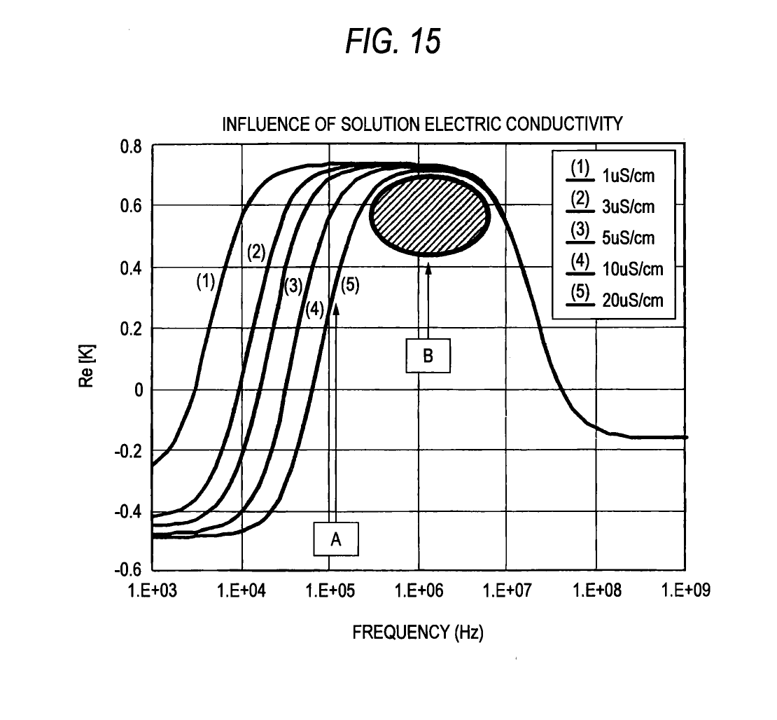

FIG. 15 is a graph showing relationships of the frequency (Hz) of the dielectrophoresis AC voltage and the real part (Re[K]) of the Clausius-Mossotti factor in the case where the solution electric conductivity (μS/cm) is set as a parameter. In a conventional microparticle number measuring method, the frequency of the dielectrophoresis AC voltage is set to the vicinity of 100 KHz indicated by arrow A, and, in the case where the solution electric conductivity is (5) 30 μS/cm, Re[K] is the vicinity of 0, and hence the positive dielectrophoretic force FDEP cannot be caused to sufficiently act.

In the embodiment, the frequency of the dielectrophoresis AC voltage is set to the vicinity of 1 MHz indicated by arrow B. Even when the solution electric conductivity is varied from (1) 1 μS/cm to (5) 30 μS/cm, therefore, Re[K] is constant in the vicinity of 0.7, and the dielectrophoretic force FDEP can be caused to sufficiently act.

Preferably, the frequency range where sufficient dielectrophoresis can be caused to act on microparticles even when the solution electric conductivity is varied, and the migration power supply unit 4 can be configured relatively simply is about 500 KHz to 10 MHz. When a frequency is selected in a range where the dielectrophoretic force FDEP is larger by about 50% or more than the maximum FDEP (MAX), the measurement can be performed more surely, and thence this is more preferable.

Here, the maximum FDEP (MAX) of the dielectrophoretic force FDEP indicates the dielectrophoretic force under conditions where Re[K] is largest in the case where the electric conductivity is lowest. In FIG. 15, for example, Re[K] at the lowest electric conductivity of 1 μS/cm is Re[K]≈0.7 in the case of the frequency of about 300 KHz, and largest.

In order that the dielectrophoretic force which is sufficient for performing the measurement can act, therefore, Re[K]> about 0.35 may be set. In the case where the electric conductivity of the solution liquid is 500 μS/cm, for example, Re[K]≈0.35 at the frequency of about 10 MHz, and the measurement can be sufficiently performed. In other words, it is shown that, when dielectrophoresis is performed at the frequency of 10 MHz, a sample liquid in which the highest electric conductivity is 500 μS/cm can be subjected to correct measurement without performing pretreatment.

When the frequency of the dielectrophoresis AC voltage is set to a range of about 500 KHz to 10 MHz, for example, a sufficient positive dielectrophoretic force FDEP can be caused to act on microparticles even when the solution electric conductivity is varied in range of about 0 to 100 μS/cm.

When the frequency is excessively low, unwanted electrolysis occurs between the electrodes 11a, 11b. Therefore, the lower limit frequency is preferably about 700 KHz. Conversely, when the frequency is excessively high, the power supply circuit is complicated. When the possibility of a measurement circuit at a high frequency is considered, therefore, the upper limit frequency is preferably lowered to 4 MHz. Consequently, the most preferable frequency range is 700 KHz to 4 MHz. Although, in the embodiment, the voltage for dielectrophoresis is 10 V, it is possible to select a lower voltage at which unwanted electrolysis does not occur, in the case where the electric conductivity of the sample is large.

For each of time periods which are preset as described above, the control calculation unit 6 and the measurement unit 5 repeat dielectrophoresis and measurement in cooperation with each other, and the measurement unit 5 stores in each time the calculated electrostatic capacitance C into the memory (step S32). When the movement of microparticles to the vicinity of the gap 13 by dielectrophoresis, and the measurement of the impedance between the electrodes 11a, 11b are repeated in this way, it is possible to check a time change of the electrostatic capacitance C between the electrodes 11a, 11b.

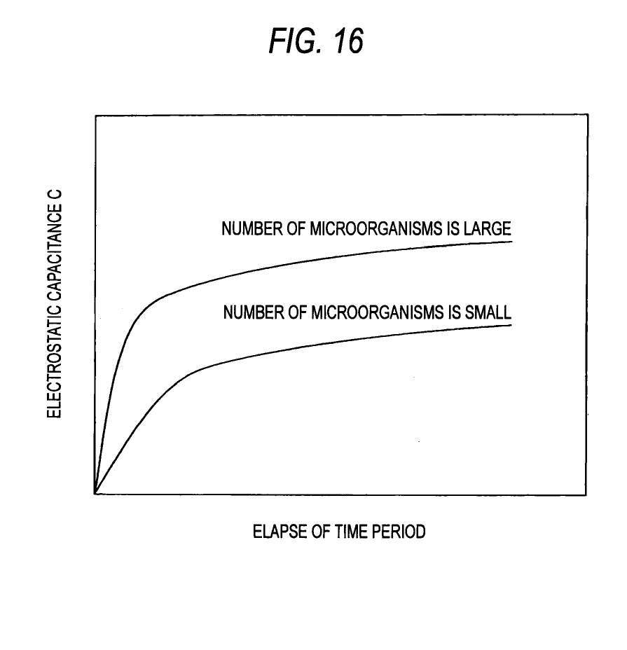

After start of the application of the AC voltage for dielectrophoresis, the impedance between the flat plate electrodes 11a, 11b is measured a predetermined number of times which are previously programmed, and, if expiration of the measurement number is detected (step S19: Yes), the control calculation unit 6 calculates the inclination of a time change of the electrostatic capacitance C between the electrodes 11a, 11b until that time as shown in FIG. 16, from results of calculation of the electrostatic capacitance C which are stored in the memory, and which are at a plurality of timings (step S33), calculates the number of the microorganisms in the sample liquid in accordance with a conversion expression that is described later, and controls the displaying means 9 so as to display a result (step S21), and the series of measurement operations is ended (step S22).

The reason why the microorganism number can be calculated by measuring the inclination of a time change of the electrostatic capacitance will be described. A microorganism is configured by a cell wall which is ion-rich and relatively high in electric conductivity, and surrounded by a cell membrane which is configured by phospholipid, and which is low in electric conductivity, and can be deemed as a minute dielectric particle. A microorganism which is deemed as a dielectric particle has a large dielectric constant as compared with a usual liquid, and further with water which has a high dielectric constant for a liquid.

As the number of microorganisms which are moved to the gap by dielectrophoresis is further increased, therefore, the apparent dielectric constant in the vicinity of the gap is further raised. It is a well-known fact that, when the dielectric constant of a medium between electrodes is changed in a state where the conditions of the electrodes are fixed, the electrostatic capacitance C is changed.

When a change of the dielectric constant between the electrodes 11a, 11b is measured through a change of the electrostatic capacitance C between the electrodes 11a, 11b, it is possible to obtain measurement results which are correlated to the number of microorganisms which are moved to the vicinity of the gap, and, i.e., that of microorganisms which exist in the sample liquid.

FIG. 16 shows an example of the time change of the electrostatic capacitance C. As seen also from FIG. 16, in a similar manner as the time change of the electrostatic capacitance C, also the inclination (gradient) of the time change of the electrostatic capacitance C in the initial stage of the measurement is increased in response to the number of microorganisms.

In the case where the microorganism number is calculated from the time change of the electrostatic capacitance C, the measurement after the transient state is more correct, and hence the measurement time period is inevitably prolonged. By contrast, in the case where the microorganism number is calculated from the inclination (gradient) of the time change of the electrostatic capacitance C in the initial stage of the measurement, there is a feature that the microorganism number can be calculated for a relatively short time period.

In this case, in order to correlate a change of the electrostatic capacitance C with the number of microorganisms of the sample liquid, a conversion expression between the electrostatic capacitance C and the microorganism number is necessary. As the conversion expression, used is a function indicating a curve which is obtained by previously measuring a calibration sample in which the microorganism number is known, by using the measurement system of the microorganism measuring apparatus which has been described in the embodiment, and performing regression analysis on dispersions from correlationships of the number of microorganisms at this time and the electrostatic capacitance C.

The conversion expression is stored into the memory of the control calculation unit 6. In the case where a sample in which the microorganism number is not known is to be measured, when the value of a change of the electrostatic capacitance C in a predetermined time period is substituted, the number of microorganisms of the sample liquid can be calculated. In the case where a conversion table is used, calculation results obtained by the conversion expression are previously stored.

As the sample in the embodiment, for example, a single microorganism species such as a yeast culture is assumed. Even in a mixed microorganism species, as far as the kinds of microorganisms and their composition ratios are not largely changed, the measurement can be performed while a similar conversion expression is previously calculated.

As described above, when a preprogrammed predetermined time period elapses after the microorganism number is calculated, the control calculation unit 6 sends a notification of measurement end to the migration power supply unit 4. Upon receiving the notification, the migration power supply unit 4 stops energization of the electrodes 11a, 11b, and opens an electromagnetic valve, and thereafter a washing process is started. Microorganisms which are collected in the vicinity of the gap are washed away by the sample liquid which enters as a result of the opening of the electromagnetic valve, and the series of operations are ended.

In the embodiment, the embodiment in the case where the single set of thin film electrodes is used has been described. This does not prohibit the use of a plurality of sets of thin film electrodes. Namely, a plurality of sets of electrodes which have the same shape as the electrodes 11a, 11b, and i.e., which have the same impedance under the same conditions may be disposed in the cell 1. In this case, the impedances of the respective electrodes are independently measured, a statistical process such as averaging of the values is performed, and then the electrostatic capacitance C is calculated, whereby a measurement result can be obtained more accurately.

Even when, among the plurality of electrodes, a value not related to the microorganism number is measured by an influence caused by unwanted impurity substances or adhesion of dust, for example, the averaging of measured values can reduce the influence. In a higher level, also a process in which abnormal values are discarded while referring measurement results of other electrodes may be performed. From the viewpoint of accuracy improvement, measurement in which a plurality of sets of electrodes having the same shape are used as described above is preferable except that the structure is slightly complicated. Since thin film electrodes are used, the miniaturization is enabled even when a plurality of sets are used.

In the embodiment, as described above, the frequency of the electric field which performs dielectrophoresis is optimized, and the microorganism number is calculated from the inclination of a time change of the inter-electrode impedance. Therefore, measurement for a short time period can be realized while avoiding an influence of the increase of the electric conductivity of the sample liquid.

### Third Embodiment

### Electric Conductivity Measurement Unit

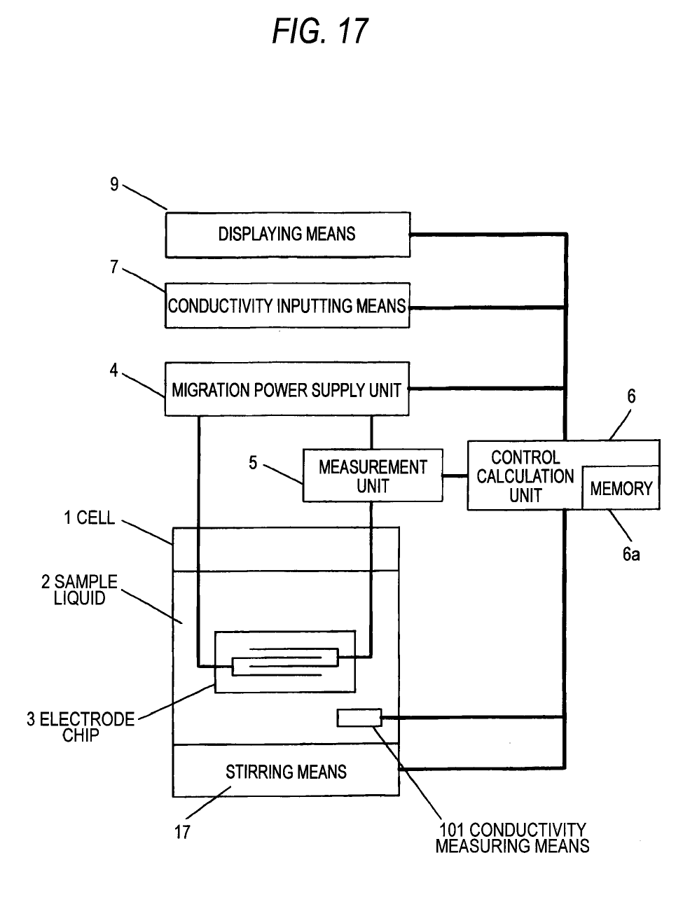

The description of the portions which are duplicated with the above-described embodiments is omitted. FIG. 17 is a configuration diagram of a microparticle measuring apparatus showing the embodiment. Conductivity measuring means 101 is placed at a position where the means is impregnated in the sample liquid 2 of the cell 1. As the conductivity measuring means 101, a usual electric conductivity measuring apparatus may be used. For example, the means is configured by electrodes for measuring the AC conductivity, and voltage applying means. The conductivity measuring means 101 is connected to the control calculation unit 6, and a result of the conductivity measurement is sent to the control calculation unit 6.

Alternatively, the electrode chip 3 may function also as the electrodes for measuring the electric conductivity. The migration power supply unit 4 which can apply an AC voltage, and the measurement unit 5 for measuring an impedance are connected to the electrodes 11a, 11b, and hence the electric conductivity can be calculated from the measured impedance. In this case, the electrode chip 3 functions also as the conductivity measuring means 101. Hereinafter, description is made assuming that the electrode chip 3 performs also the role of the conductivity measuring means 101. When the electrode chip 3 of the measuring means functions also as the conductivity measurement electrodes, there is a merit that the apparatus configuration can be simplified.

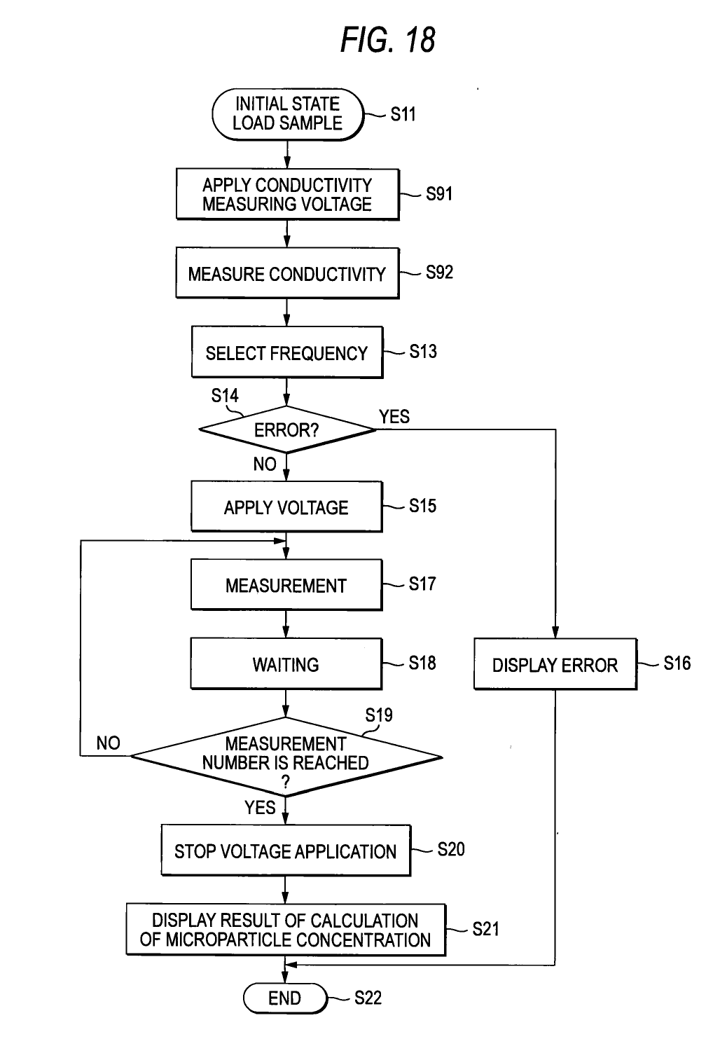

FIG. 18 is a flowchart illustrating a microorganism measuring method of the embodiment. Hereinafter, a series of flows from introduction of a sample to measurement of microparticles in the cell 1 will be described with reference to the flowchart. First, in an initial state, the sample liquid 2 containing microparticles is loaded into the cell 1 (step S11).

When, at a predetermined timing, the control enters into measurement operations which are previously set by programs, the control calculation unit 6 instructs the migration power supply unit 4 so as to apply a voltage (hereinafter, referred to as the conductivity measurement voltage) for measuring the electric conductivity, in order to measure the electric conductivity of the sample liquid 2. At this time, preferably, the level of the conductivity measurement voltage is a value which is smaller than a voltage (hereinafter, referred to as the microparticle measurement voltage) for measurement of microparticles that is subsequent thereto.

If the microparticle measurement voltage is applied, microparticles are trapped between the electrodes 11a, 11b by the dielectrophoretic force, the impedance change is caused, and an error occurs in a result of measurement of the electric conductivity of the sample liquid 2. As the conductivity measurement voltage, therefore, a voltage at which microparticles are not trapped between the electrodes 11a, 11b, and the electric conductivity can be sufficiently measured is applied. In the embodiment, an AC voltage of 1.0 Vp-p is applied (step S91).

The conductivity measurement voltage is applied between the electrodes 11a, 11b, and a predetermined stabilization time period elapses. Thereafter, the measurement unit 5 starts measurement of the impedance between the electrodes 11a, 11b. Then, the impedance measurement is performed only for a predetermined measurement time period, a result of the measurement is sequentially passed to the control calculation unit 6, and the control calculation unit 6 calculates the electric conductivity of the sample liquid from the result of the impedance measurement.

In calculation of the electric conductivity, a method in which several measurements are performed during the predetermined measurement time period, and the measurements are averaged is advantageous because the measurement accuracy is improved. In a method of calculating the electric conductivity, specifically, a conductance which is the inverse of the resistance component R between the electrodes 11a, 11b which is indicated by (Exp. 7) can be calculated, and the electric conductivity can be calculated by using the proportional relationship of the conductance and the electric conductivity.

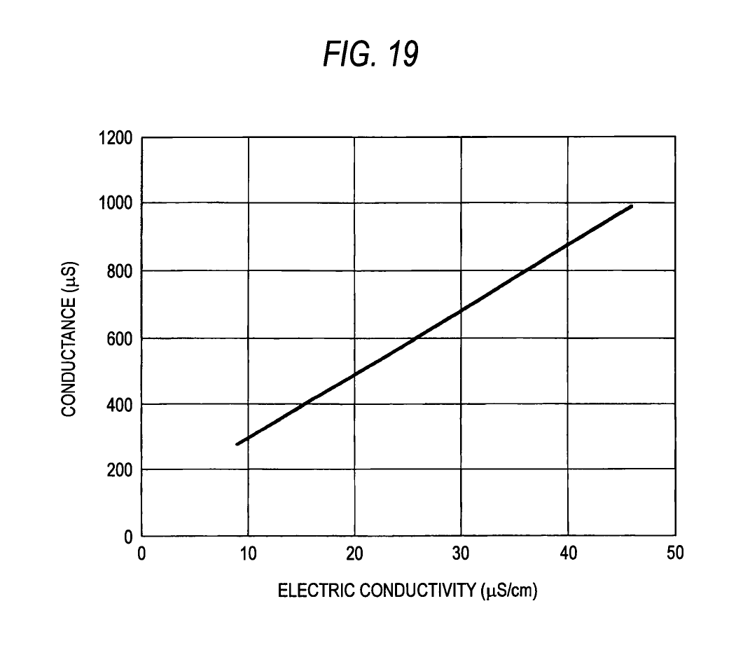

FIG. 19 shows results of measurement of conductances of sample liquids of different electric conductivities. The electric conductivity can be calculated from the conductance by using the calibration curve of the proportional relationship. The calibration curve data are incorporated in the memory 6a, and the control calculation unit 6 calculates (step S92).

Hereinafter, the processes subsequent to the frequency selection (step S13) are identical with those of the above-described embodiments, and hence description is omitted. When the electric conductivity of the sample liquid is directly measured in this way, there is a merit that the correct electric conductivity of the sample liquid enables the frequency selection.

The measurement of the electric conductivity of the sample liquid may be estimated also from the impedance measurement result in a state which is immediately after application of the voltage for dielectrophoresis, and in which microparticles are not almost trapped to the gap 13. In this case, the measurement steps can be realized by the flowchart shown in FIG. 9. The conductance is calculated from the measurement result of the initial measurement (step S17), and the electric conductivity is calculated.

As described above, when the electric conductivity is measured by the voltage for dielectrophoresis, the measurement step is omitted. Consequently, there are effects that the measurement time period is shortened, and the circuit of the migration power supply unit 4 can be simplified because the applied voltage is single.

### Fourth Embodiment

### Electric Conductivity Correction

The description of the portions which are duplicated with the above-described embodiments is omitted. In the frequency selection tables shown in Table 2 and Table 3, the case where the dielectrophoretic force is changed at the selected frequency in the sample liquid conductivity range may be assumed.

In the range of conductivity of 0 to 300 μS/cm shown in Table 3, at 800 KHz, for example, Re[K] indicating the dielectrophoretic force is seen to be reduced in force by about 10% at 100 μS/cm, as compared with the value of 5 μS/cm in which the conductivity is lowest.

Therefore, also the number of microparticles which are trapped between the electrodes 11a, 11b by dielectrophoresis is reduced in accordance with the lowering of the dielectrophoretic force, and also the measuring response is lowered. When this is used as it is as the measurement result, the correctness of the result is lost, and hence the variation must be corrected.

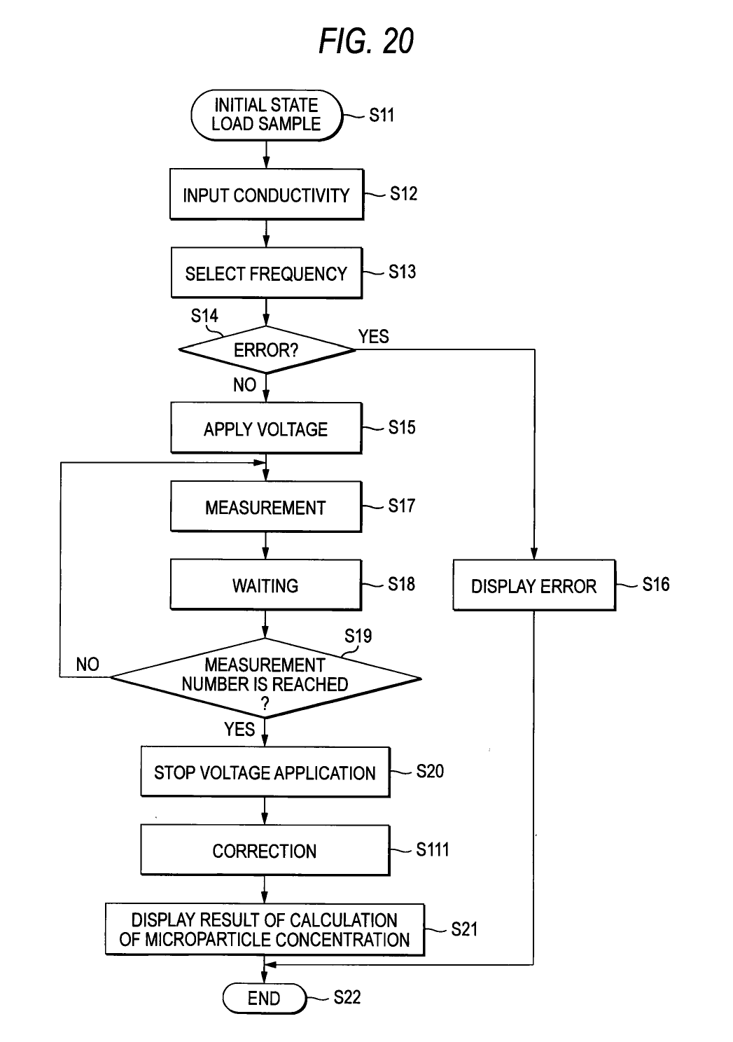

FIG. 20 is a flowchart illustrating a microparticle measuring method of the embodiment. Hereinafter, the microparticle measuring method of the embodiment will be described with reference to the flowchart. The steps other than step S111 are identical with those of the above-described embodiments, and hence description is omitted.

Microparticles are caused to perform dielectrophoresis, the process is measured by impedance measurement or the like, the control calculation unit 6 sequentially stores a result of the measurement, and calculates the change in the form of the inclination, and thereafter a multiplication of the measurement result (the inclination of the change) by a correction coefficient which is recorded in an inclination correction table shown in Table 4 from the value of the sample liquid electric conductivity is set as a final measurement result (step S111). The inclination correction table is incorporated in the memory 6a.

TABLE 4

| Sample liquid electric conductivity (μS/cm) | Correction coefficient |
|---|---|
| 1-12 | 1.2 |
| 13-26 | 1.3 |
| 27-44 | 1.4 |
| 45-69 | 1.5 |
| 70-100 | 1.6 |
| 101-150 | 1.7 |
| 150-200 | 1.8 |
| 201-250 | 1.9 |
| 250-300 | 2.0 |

The inclination correction table is preferably determined by conducting the following experiment. Sample liquids having the same microparticle concentration and different electric conductivities are prepared, and measurement is performed on each of the sample liquids. The measuring response of a sample liquid in which, as a result, the electric conductivity is lowest, or in other words the dielectrophoretic force is strongest, and the measuring response is largest is set as a reference value. The ratio of the measuring response of a sample liquid in which the electric conductivity is high, the dielectrophoretic force is weak, and the measuring response is low, to the reference value may be set as an inclination correction value.

When the measurement result is corrected by the electric conductivity of the sample liquid 2 as described above, the correctness of the measurement result is maintained.

### Fifth Embodiment

### Measurement Limit for Each Electric Conductivity

The description of the portions which are duplicated with the above-described embodiments is omitted. In the frequency selection tables shown in Table 2 and Table 3, the case where the dielectrophoretic force is changed at the selected frequency in the sample liquid conductivity range may be assumed.

In the case of conductivity of 0 to 300 μS/cm shown in Table 3, for example, Re[K] indicating the dielectrophoretic force is seen to be reduced in force by about 10% at 100 μS/cm, as compared with the value of 5 μS/cm in which the conductivity is lowest. Also the number of microparticles which are trapped between the electrodes 11a, 11b by dielectrophoresis is reduced in accordance with the reduction of the dielectrophoretic force, and also the measuring response is lowered.

Here, the case where the number of microparticles which are contained in the sample liquid 2 is large, or in other words the microparticle concentration is high will be considered. In this case, even when the dielectrophoretic force is reduced to some extent, the signal can be taken out as far as the number of microparticles which are trapped between the electrodes 11a, 11b is within the measurement limit which is governed by the S/N of the measurement unit 5, and hence a correct measurement result can be obtained by correction based on the reduction of the dielectrophoretic force. By contrast, in the case where the dielectrophoretic force is small and the microparticle concentration is low, the number exceeds the measurement limit of the measurement unit 5, and the signal cannot be taken out. Even when correction is performed, therefore, a correct measurement result cannot be obtained.

This means that the dielectrophoretic force is varied in accordance with the sample liquid electric conductivity, and hence the measurement limit microparticle concentration of the measuring apparatus is different in accordance with the sample liquid electric conductivity. When the measurement limit microparticle concentration is set to a certain fixed value, the conditions in which the measurement is enabled is restricted as a whole, and the usable range of the apparatus is extremely limited. Therefore, a measurement lower limit microparticle concentration is set in accordance with the value of the sample liquid electric conductivity, so that, in the case where the sample liquid electric conductivity is high, some kind of result can be presented although the microparticle concentration range is limited.

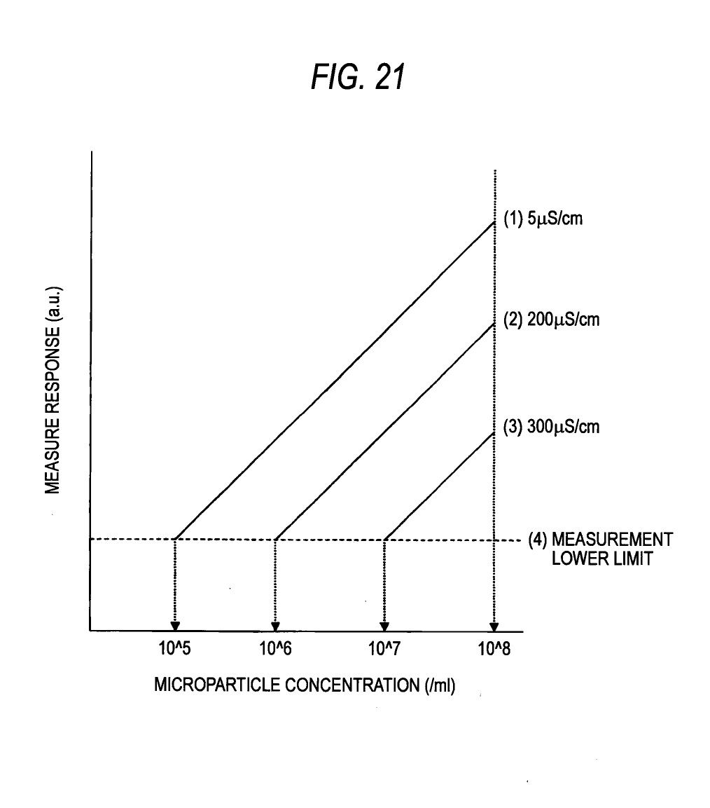

FIG. 21 is a graph showing measuring responses with respect to the microparticle concentration in a sample liquid when the sample liquid electric conductivity is set to (1) 5 μS/cm, (2) 200 μS/cm, and (3) 300 μS/cm. In the graph, (4) is the measurement lower limit of the measurement system which is governed by the S/N of the measurement unit 5. As a result of trapping of microparticles to the gap 13 by the dielectrophoretic force, when the measuring response does not exceed the measurement lower limit, it is not impossible to correctly measure the microparticle concentration. The measuring response is expressed while the measurement lower limit microparticle concentration in the case of (1) where the sample liquid electric conductivity is lowest is normalized to 1.

In the case of (1), for example, the measurement lower limit microparticle concentration is 10̂5 cells/ml. When the measuring response is equal to or smaller than 1, a result which is quantitatively converted to a numerical value cannot be presented. However, the result of “10̂5 cells/ml or less” can be presented. For example, this is effective in measurement for the purpose of checking whether, with respect to 10̂5 cells/ml, the microparticle concentration is equal to or higher than the value and the degree of concentration or equal to or lower than the value.

Similarly, in the case of (2), the measurement lower limit microparticle concentration is 10̂6 cells/ml, and, in the case of (3), the measurement lower limit microparticle concentration is 10̂7 cells/ml. As a measurement lower limit microparticle concentration table shown in Table 5, this is incorporated in the memory 6a, and, in accordance with the electric conductivity which is input or measured by the control calculation unit 6, the measurement lower limit microparticle concentration is referred. The result of the reference is output to the outside by using the displaying means 9 or the like.

TABLE 5

| | Detection lower limit |
|---|---|
| Sample liquid electric conductivity (μS/cm) | (/ml) |
| 1-100 | 10\hat{ }5 |
| 100-200 | 10\hat{ }6 |
| 200-300 | 10\hat{ }7 |

When an effective concentration range in the measurement is known, it is possible to interpret the result. In the case of (2) in which the sample liquid electric conductivity is 200 μS/cm, when the measurement result is “10̂6 cells/ml or less”, for example, it is known that the measurement result is at least equal to or lower than the concentration. When a more detailed test is required, the sample liquid may be transferred to, for example, another test which is further highly sensitive. The embodiment can exert a function of screening.

The measurement lower limit microparticle concentration table may include the electric conductivity range where the measurement is impossible. In Table 5, 500 μS/cm or more corresponds to the electric conductivity range where the measurement is impossible. When the electric conductivity is equal to or higher than the value, it is impossible to obtain a dielectrophoretic force which is sufficient for obtaining a measuring response, and measurement cannot be performed. In this case, the control calculation unit 6 notifies to the outside that the sample liquid electric conductivity exceeds the allowable range and measurement cannot be performed. When the notification is performed, a measure such as that the electric conductivity is reduced within the allowable range by dilution, ion exchange, or the like may be taken.

### Example 1

### Measurement of Escherichia coil as Standard Sample

(1) Preparation of Sample Liquid

A sample obtained by harvesting Escherichia coil K-12 strain (NBRC 3301, National Institute of Technology and Evaluation, Japan) in which aerobic cultivation was performed at 37° C. and for 16 hours on a standard agar medium (MB0010, EIKEN KIZAI K.K.), taken by a bacteria spreader from the agar plate, and suspending the harvested strain in 0.1 M D-mannitol solution (the electric conductivity, about 5 μS/cm) was set as a standard sample. The standard sample was adequately diluted to produce a dilution series so as to attain a suspension concentration of 10̂5 to 10̂8 cfu/ml.

The suspension concentration was defined by smearing the standard sample which is adequately diluted, on the standard agar plate, and counting the number of colonies which were grown by performing aerobic cultivation at 37° C. for 16 hours. An NaCl solution is adequately added to the standard sample, thereby performing adjustment so that the sample liquid electric conductivity is 5 to 200 μS/cm. The sample liquid electric conductivity was measured by an electric conductivity meter (B-173, Horiba, Ltd.).

(2) Measuring Apparatus

The measuring apparatus of FIG. 5 was used. The amplitude of the applied voltage was 5 Vp-p, and the frequency was 100 KHz and 800 KHz in order to search the optimum frequency. After the impedance measurement for 60 seconds, the inclination of the capacitance was evaluated as a measuring response.

(3) Results

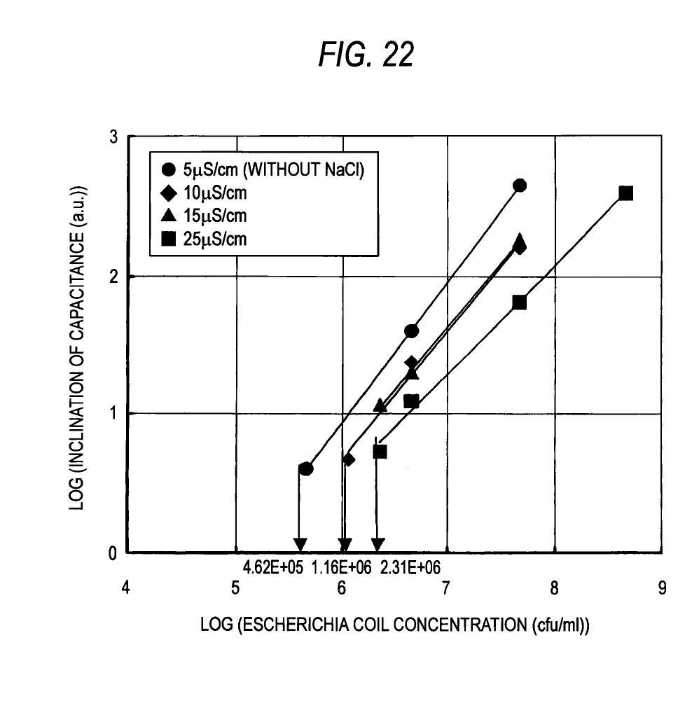

FIG. 22 shows values which were obtained by logarithm converting the concentration of Escherichia coil in the abscissa and a normalized capacitance inclination in the ordinate. The frequency is 100 KHz. The measurement lower limit in the case where the electric conductivity was 5 μS/cm was 4.62×10̂5 cfu/ml, that in the case of 10 μS/cm was 1.16×10̂6 cfu/ml, and that in the case of 25 μS/cm was 2.31×10̂6 cfu/ml, so that the measuring response was lowered in accordance with the rise of the sample liquid electric conductivity. When the electric conductivity was further raised to be 50 μS/cm or more, no measuring response was obtained.

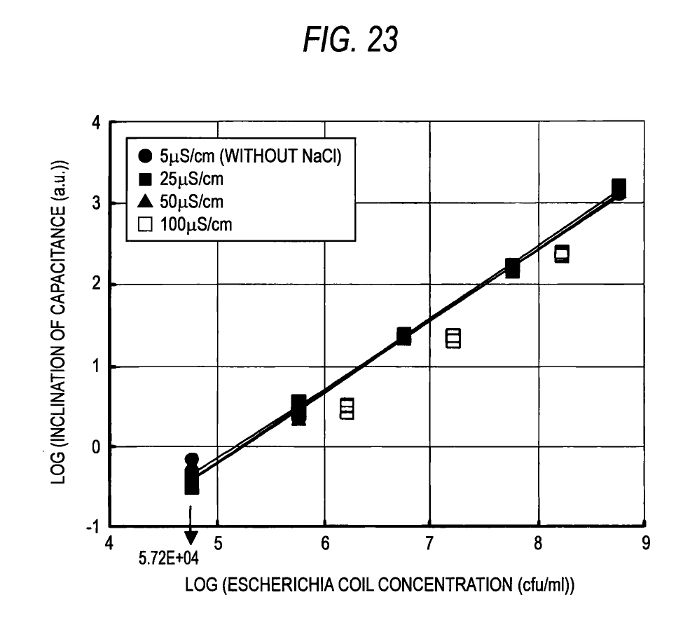

FIG. 23 shows results of measurements in the case where the frequency is 800 KHz. The measuring response is obtained until the sample liquid electric conductivity is 100 μS/cm. As compared with the case of 100 KHz, the sample liquid electric conductivity which can be measured is high, and hence it can be said that the frequency is a more optimum frequency.

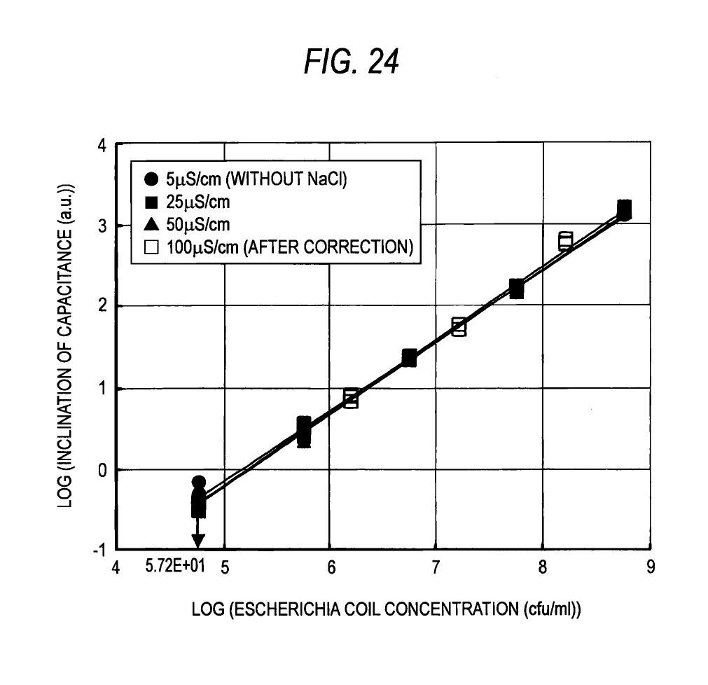

In the case where the electric conductivity is 100 μS/cm, the measuring response value at 800 KHz is lowered as compared with the case of 50 μS/cm or less. FIG. 24 shows results of correction of the value using the conductivity correction table of Table 2. The figure shows that, when the correction is performed, the dielectrophoretic force is lowered by the rise of the electric conductivity, and a correct Escherichia coil concentration can be estimated from data in which the measuring response is lowered.

### Example 2

### Measurement of Oral Bacteria

(1) Preparation of Sample

In order to perform measurement demonstration by sample liquids having various electric conductivities, oral bacteria were measured and evaluated as a typical example. A sample obtained by rubbing three times the tongue dorsum in the oral cavity with a sterile swab (Ex001, DENKA SEIKEN Co., Ltd.), and suspending the harvested substance in 7 ml of 0.1 M D-mannitol solution (the electric conductivity, about 5 μS/cm) was set as a sample liquid.

In the oral cavity, saliva which abundantly contains ions of sodium, calcium, and the like exists. Therefore, the electric conductivity of the suspending sample liquid which is harvested from the oral cavity is raised. In sample liquids in which the total specimen number was 98, the average electric conductivity was 55 μS/cm, and the maximum electric conductivity was 200 μS/cm.

The concentration of bacteria in the sample liquid was obtained in the following manner. The sample liquid was adequately diluted, the diluted sample liquid was smeared on a blood agar medium (E-MP23, EIKEN KIZAI K.K.), and anaerobic cultivation was performed at 37° C. for 48 hours. A result of counting of the number of grown colonies was converted from the dilution rate to be set as the concentration of bacteria in the sample liquid.

(2) Measuring Apparatus

The measuring apparatus of FIG. 5 was used. The amplitude of the applied voltage was 10 Vp-p, and the frequency was 800 KHz. After the impedance measurement for 20 seconds, the inclination of the capacitance was set as a measuring response, and the value which is corrected by using the electric conductivity correction table shown in Table 4 was evaluated as a final measurement result.

(3) Results

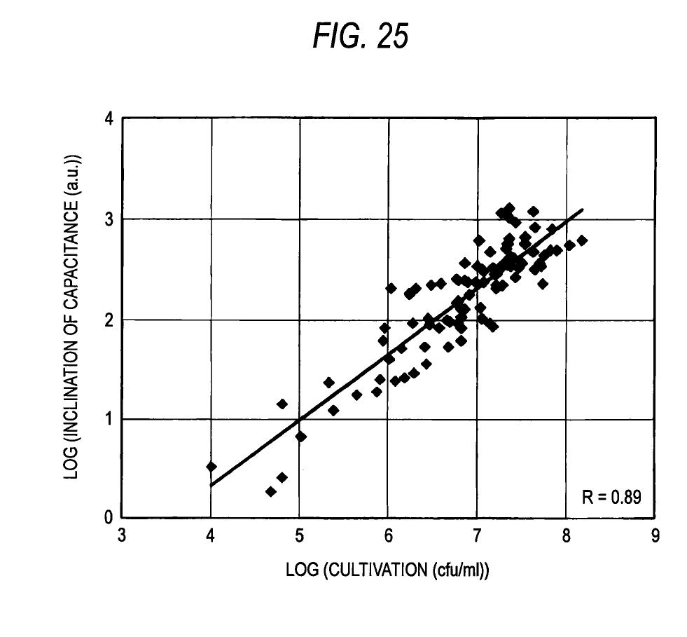

FIG. 25 shows values which were obtained by logarithm converting the concentration of cultivated bacteria in the abscissa and a normalized capacitance inclination in the ordinate. In the range of the concentration of bacteria of 10̂4 to 10̂8 cells/ml, the correlation coefficient R=0.89 and the very excellent linearity is obtained. From the above results, in the range of the concentration of bacteria of 10̂4 to 10̂8 cells/ml, and the sample liquid electric conductivity of 200 μS/cm or less, effectiveness of the microparticle measuring apparatus and microparticle measuring method of the invention was confirmed.

Although the invention has been described in detail and with reference to the specific embodiments, it is obvious to those skilled in the art that various changes and modifications can be made without departing from the spirit and scope of the invention.

The application is based on Japanese Patent Application (No. 2007-241345) filed Sep. 18, 2007, and its disclosure is incorporated herein by reference.

### INDUSTRIAL APPLICABILITY

The invention is useful as a microparticle measuring apparatus and the like in which an influence of the electric conductivity of a solution containing microparticles is avoided without performing pretreatment, and which can measure highly sensitively and highly accurately the number of the microparticles contained in the solution.

1. A microparticle measuring apparatus comprising:
a cell into which a liquid containing microparticles is to be introduced;
at least one pair of electrodes which are immersed in the cell;
a migration power supply unit which applies an AC voltage of a frequency at which a dielectrophoretic force exerted on the microparticles is equal to or larger than a predetermined value, between the pair of electrodes;
a measurement unit which measures the microparticles in the cell; and
a control calculation unit which calculates a result of the measurement performed by the measurement unit, and which calculates a concentration of the microparticles in the liquid.

2. The microparticle measuring apparatus according to claim 1,
wherein the control calculation unit has a frequency table which stores frequencies of the AC voltage at which the dielectrophoretic force exerted on the microparticles is equal to or larger than the predetermined value, in a case where the solution electric conductivity is set as a parameter.

3. The microparticle measuring apparatus according to claim 1,
wherein the migration power supply unit applies an AC voltage of a frequency of 500 KHz to 10 MHz between the pair of electrodes.

4. The microparticle measuring apparatus according to claim 1,
wherein the measurement unit measures an impedance between the pair of electrodes, and
wherein the control calculation unit calculates a time change of the impedance between the pair of electrodes to calculate a number of the microparticles in the cell.

5. The microparticle measuring apparatus according to claim 4,
wherein the microparticles are collected between a gap of the pair of electrodes by the dielectrophoretic force in positive dielectrophoresis.

6. The microparticle measuring apparatus according to claim 4,
wherein the control calculation unit calculates a number of the microparticles in the sample liquid from a time change of a capacitance between the pair of electrodes.

7. The microparticle measuring apparatus according to claim 4,
wherein an electric conductivity of the sample liquid is in a range of 0 to 500 μS/cm.

8. The microparticle measuring apparatus according to claim 1,
wherein the migration power supply unit applies an AC voltage of a frequency at which a dielectrophoretic force is larger by about 50% or more than a maximum dielectrophoretic force in a case where the solution electric conductivity is lowest.

9. The microparticle measuring apparatus according to claim 1, comprising:
a solution electric conductivity measurement unit which measures a solution electric conductivity.

10. The microparticle measuring apparatus according to claim 9, comprising:
at least one pair of electrodes for measuring the solution electric conductivity,
wherein an impedance between the electrodes for measuring the solution electric conductivity is measured, thereby measuring the solution electric conductivity.

11. The microparticle measuring apparatus according to claim 9,
wherein the pair of electrodes are used for performing dielectrophoresis and measuring the solution electric conductivity.

12. The microparticle measuring apparatus according to claim 9,
wherein an amplitude of voltage for measuring the solution electric conductivity, and an amplitude of voltage for dielectrophoresis are different from each other.

13. The microparticle measuring apparatus according to claim 12,
wherein the amplitude of voltage for measuring the solution electric conductivity is lower than the amplitude of voltage for dielectrophoresis.

14. The microparticle measuring apparatus according to claim 9,
wherein the solution electric conductivity is calculated from an initial impedance value in a process in which dielectrophoresis is performed.

15. The microparticle measuring apparatus according to claim 1,
wherein the control calculation unit corrects a result of the measurement in accordance with a solution electric conductivity.

16. The microparticle measuring apparatus according to claim 1,
wherein the control calculation unit has a detection lower-limit table which stores a detection lower limit corresponding to a solution electric conductivity.

17. The microparticle measuring apparatus according to claim 16, comprising:
notifying means for notifying the detection lower limit corresponding to the solution electric conductivity, to an outside.

18. A microparticle measuring apparatus comprising:
a cell into which a liquid containing microparticles is to be introduced;
at least one pair of electrodes which are immersed in the cell;
a migration power supply unit which applies an AC voltage of a frequency in a range of about 500 KHz to 10 MHz between the pair of electrodes; and
a measurement calculation unit which measures the microparticles in the cell.

19. A microparticle measuring method comprising:
applying an AC electric field between a pair of electrodes which are immersed in a sample liquid containing microparticles;
placing the microparticles at a predetermined position by a dielectrophoretic force; and
measuring a concentration of the microparticles in the sample liquid,
wherein said microparticle measuring method comprising:
a step of setting a frequency of the AC electric field so that, even when a solution electric conductivity is changed, the dielectrophoretic force is equal to or larger than a predetermined value.

20. The microparticle measuring method according to claim 19, comprising:
a step of, in a case where the frequency of the AC electric field is changed while the solution electric conductivity is set as a parameter, setting the frequency of the AC electric field so that the dielectrophoretic force is larger by about 50% or more than a maximum dielectrophoretic force in a case where the solution electric conductivity is lowest.

21. The microparticle measuring method according to claim 19, comprising:
a step of measuring the solution electric conductivity; and
a step of selecting the frequency of the AC electric field so that, even when the solution electric conductivity is changed, the dielectrophoretic force is equal to or larger than the predetermined value.

22. The microparticle measuring method according to claim 21, comprising:
a step of correcting the concentration of the microparticles in the sample liquid by the measured solution electric conductivity.

23. The microparticle measuring method according to claim 19, comprising:
a step of collecting the microparticles between the pair of electrodes by the dielectrophoretic force.

24. The microparticle measuring method according to claim 23, comprising:
a step of measuring an impedance between the pair of electrodes.

25. The microparticle measuring method according to claim 24, comprising:
a step of measuring a capacitance between the pair of electrodes; and
a step of measuring a concentration of the microparticles in the sample liquid from a time change of the capacitance.

26. The microparticle measuring method according to claim 24,
wherein an electric conductivity of the sample liquid is in a range of 0 to 500 μS/cm.

27. A microparticle measuring method comprising:
applying an AC electric field between a pair of electrodes which are immersed in a sample liquid containing microparticles;
placing the microparticles at a predetermined position by a dielectrophoretic force; and
measuring a concentration of the microparticles in the sample liquid,
wherein a frequency of the AC electric field is in a range of about 500 KHz to 10 MHz.
